(19) United States
(12) Patent Application Publication
(10) Pub. No.: US 2025/0256510 A1
(43) Pub. Date: Aug. 14, 2025

(54) LIQUID DISCHARGE HEAD AND LIQUID DISCHARGE APPARATUS

(71) Applicants: Hisayoshi OHSHIMA, Kanagawa (JP); Eiri SAGAE, Kanagawa (JP); Toshihiro KANEMATSU, Kanagawa (JP); Tomoko KUROSAWA, Kanagawa (JP)

(72) Inventors: Hisayoshi OHSHIMA, Kanagawa (JP); Eiri SAGAE, Kanagawa (JP); Toshihiro KANEMATSU, Kanagawa (JP); Tomoko KUROSAWA, Kanagawa (JP)

(21) Appl. No.: 19/023,678

(22) Filed: Jan. 16, 2025

(30) Foreign Application Priority Data
Feb. 9, 2024 (JP) 2024-018674

(51) Int. Cl. B41J 2/165; B05B 1/30

(52) U.S. Cl. CPC B41J 2/165; B05B 1/3046

(57) ABSTRACT

A liquid discharge head includes a needle valve to open and close a nozzle, the needle valve including: a rear-end member; and a leading-end member detachably attached to the rear-end member; and a mover coupled to the rear-end member of the needle valve, the mover to move the needle valve, in an axial direction, between: a closed position at which the needle valve contacts the nozzle to close the nozzle; and an open position at which the needle valve is separated from the nozzle to open the nozzle. The needle valve further includes: an axial force generator to generate an axial force to abut the leading-end member against the rear-end member; and an axial center restrictor to restrict a position of an axial center of the leading-end member relative to an axial center of the rear-end member.

### CROSS-REFERENCE TO RELATED APPLICATIONS

This patent application is based on and claims priority pursuant to 35 U.S.C. § 119 (a) to Japanese Patent Application No. 2024-018674, filed on Feb. 9, 2024, in the Japan Patent Office, the entire disclosure of which is hereby incorporated by reference herein.

### BACKGROUND

### Technical Field

The present embodiment relates to a liquid discharge head and a liquid discharge apparatus.

### Related Art

A liquid discharge head includes a needle valve that opens and closes a nozzle, and a mover that moves the needle valve between a closed position at which the nozzle is closed and an open position at which the nozzle is opened, in which the needle valve includes a rear-end member connected to the mover and a leading-end member attached to the rear-end member.

### SUMMARY

In an aspect of the present disclosure, a liquid discharge head that includes a needle valve to open and close a nozzle, the needle valve including: a rear-end member; and a leading-end member detachably attached to the rear-end member; and a mover coupled to the rear-end member of the needle valve, the mover to move the needle valve, in an axial direction, between: a closed position at which the needle valve contacts the nozzle to close the nozzle; and an open position at which the needle valve is separated from the nozzle to open the nozzle. The needle valve further includes: an axial force generator to generate an axial force to abut the leading-end member against the rear-end member; an axial center restrictor to restrict a position of an axial center of the leading-end member relative to an axial center of the rear-end member; and an inclination restrictor to restrict an inclination of the leading-end member relative to the rear-end member.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is an entire perspective view of a liquid discharge head;

FIG. 2 is a schematic configuration diagram illustrating a head unit;

FIG. 3 is a schematic cross-sectional view of the liquid discharge head;

FIGS. 4A and 4B are schematic configuration diagrams illustrating a basic configuration of a liquid discharge module;

FIG. 5 is a diagram for illustrating replacement of a leading-end member and a nozzle plate;

FIGS. 6A to 6D are diagrams illustrating an example of the leading-end member to be replaced;

FIG. 7A illustrates a comparative example in which trouble occurs such that the axial center of the leading-end member is shifted in a direction orthogonal to a Z direction relative to the axial center of a rear-end member, and FIG. 7B illustrates a comparative example in which trouble occurs such that the leading-end member is attached to the rear-end member in an inclined manner;

FIG. 8A illustrates a comparative example in which trouble occurs such that the axial center of the leading-end member is shifted from the center of the nozzle in a case where a leading-end member shape is a concave shape, and FIG. 8B illustrates a comparative example in n which trouble occurs such that the axial center of the leading-end member is shifted from the center of the nozzle in a case where the leading-end member shape is a conical shape;

FIG. 9 is a schematic diagram illustrating the vicinity of a connection portion between the leading-end member and the rear-end member;

FIGS. 10A and 10B are diagrams for illustrating a dimensional example of a needle valve;

FIG. 11 is a diagram for illustrating a positional shift of the axial center of the leading-end member relative to the axial center of the rear-end member and measurement of the inclination of the leading-end member relative to the rear-end member;

FIG. 12A to 12C are diagrams illustrating another example of a unit for generating an axial force;

FIGS. 13A and 13B are schematic configuration diagrams illustrating an example in which a diaphragm seal is used as a seal for sealing between a storage and a flow path;

FIG. 14 is a schematic configuration diagram illustrating a first modification of the present embodiment;

FIG. 15 is a schematic configuration diagram illustrating a second modification of the present embodiment;

FIGS. 16A and 16B are schematic configuration diagrams illustrating a third modification of the present embodiment;

FIG. 17 is a schematic configuration diagram illustrating a fourth modification of the present embodiment;

FIGS. 18(a) to 18(d) are diagrams illustrating an example of a diaphragm interposing structure of the needle valve;

FIG. 19 is a schematic configuration diagram illustrating a fifth modification of the present embodiment;

FIG. 20 is a schematic diagram of a needle valve in a fifth modification;

FIG. 21 is a schematic configuration diagram of an inkjet printer;

FIGS. 22A and 22B are perspective views illustrating an arrangement example of an inkjet printer relative to an automobile;

FIG. 23 is a schematic perspective view illustrating an example of an electrode manufacturing apparatus; and

FIG. 24 is a schematic perspective view illustrating another example of the electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A best mode for carrying out the present embodiment will be hereinafter described with reference to the drawings. It is to be understood that those skilled in the art can easily change and correct the present embodiment within the scope of claims to form other embodiments, and these changes and corrections are included in the scope of claims. The following description is an example of the best mode of the present embodiment, and does not limit the scope of claims.

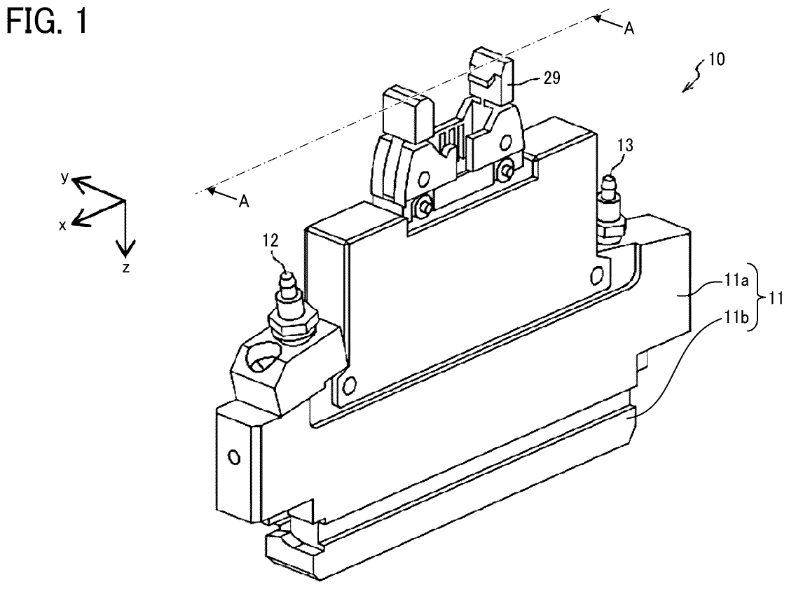

FIG. 1 is an entire perspective view of a liquid discharge head 10. In FIG. 1, a longitudinal direction of the liquid discharge head 10 (arrangement direction of nozzles 14) is defined as an X direction, and a lateral direction of the liquid discharge head 10 is defined as a Y direction. A height direction of the liquid discharge head 10 (an opening/closing direction of a needle valve 17, a moving direction of the needle valve 17, a liquid discharge direction from the nozzle 14) is defined as a Z direction. In the subsequent drawings, the definition of coordinates is similar unless otherwise specified.

The liquid discharge head 10 is provided with a housing 11 as a housing. The housing 11 is made of metal or resin. The housing 11 includes a nozzle housing 11b and a main body housing 11a. The main body housing 11a is provided with a connector 29 for communication of electric signals on its upper portion. The housing 11 includes a supply port 12 for supplying liquid such as ink into a head on one end in the X direction, and a recovery port 13 for ejecting the liquid from the head on the other end in the X direction.

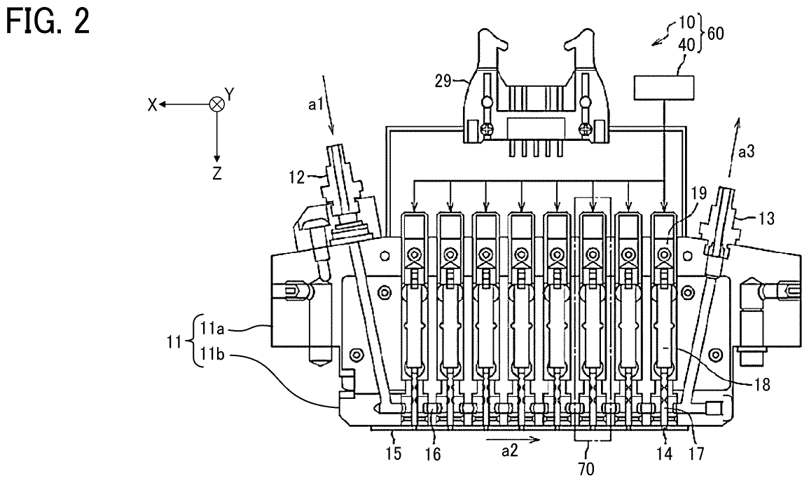

FIG. 2 is a schematic configuration diagram illustrating a head unit 60, and is also a cross-sectional view of the liquid discharge head 10 taken along line A-A in FIG. 1. The head unit 60 includes the liquid discharge head 10 and a drive controller 40.

The liquid discharge head 10 includes a nozzle plate 15. The nozzle plate 15 is joined to the nozzle housing 11b. On the nozzle plate 15, a plurality of nozzles 14 for discharging the liquid is arranged in the longitudinal direction (X direction) of the liquid discharge head 10. A liquid chamber 16 through which the liquid flows is provided in the housing 11. The liquid chamber 16 serves as a path through which the liquid supplied from the supply port 12 is transmitted to the recovery port 13 via the nozzle plate 15. The liquid is transmitted on the liquid chamber 16 in a direction indicated by arrows a1 to a3 illustrated in FIG. 2.

With the above-described configuration, the supply port 12 takes in the liquid in a pressurized state from outside, transmits the liquid in the direction indicated by arrow a1, and supplies the ink to the liquid chamber 16. The liquid chamber 16 transmits the liquid from the supply port 12 in the direction indicated by arrow a2. The recovery port 13 ejects the liquid that is not discharged from the nozzles 14 arranged along the liquid chamber 16 in the direction indicated by arrow a3.

A plurality of liquid discharge modules 70 is arranged between the supply port 12 and the recovery port 13. The number of the liquid discharge modules 70 corresponds to the number of the nozzles 14, and in this example, a configuration is illustrated in which eight liquid discharge modules 70 corresponding to eight nozzles 14 arranged in one row are provided. The number and arrangement of the nozzles 14 and the liquid discharge modules 70 are not limited to the above description. For example, the number of the nozzles 14 and the number of the liquid discharge modules 70 may be one instead of plural. The number may be eight or larger or smaller. The nozzles 14 and the liquid discharge modules 70 may be arranged in a plurality of rows instead of one row.

Each liquid discharge module 70 is provided with the needle valve 17 that opens and closes the nozzle 14 and a piezoelectric element 18 as an actuator that drives the needle valve 17. By displacing the piezoelectric element 18, the needle valve 17 is opened and closed, and the liquid is discharged from the nozzle 14.

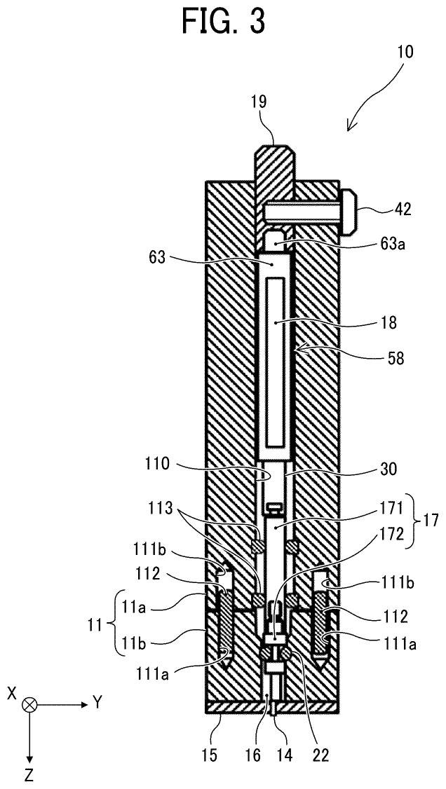

The housing 11 is provided with a plurality of storages 110 (refer to FIG. 3) as mover storages for storing a moving mechanism 58 (refer to FIG. 3) of the liquid discharge module 70. Each storage 110 is provided with a piezoelectric element restriction member 19 that restricts a position of the piezoelectric element 18 in the Z direction.

A sealing member as a sealing portion is provided in a leading-end member portion of the needle valve 17. When the sealing member of the needle valve 17 is pressed against the nozzle plate 15, the sealing member is compressed, so that the needle valve 17 surely closes the nozzle 14.

When a voltage is applied to the piezoelectric element 18 by the drive controller 40, the piezoelectric element 18 is displaced in the Z direction, and the needle valve 17 is raised in a direction separated from the nozzle 14 by the moving mechanism 58 to be described later. As a result, the needle valve 17 is separated from the nozzle 14 to open the nozzle 14. As a result, the liquid pressurized and supplied to the liquid chamber 16 is discharged from the nozzle 14. When no voltage is applied to the piezoelectric element 18, the needle valve 17 closes the nozzle 14. In this state, even if the liquid is pressurized and supplied to the liquid chamber 16, the liquid is not discharged from the nozzle 14.

The drive controller 40 includes a waveform generation circuit 41 serving as a drive pulse generator and an amplification circuit. The waveform generation circuit generates a drive pulse waveform to be described later, and the amplification circuit amplifies a voltage value to a necessary value. The amplified voltage is applied to the piezoelectric element 18. By the application of the voltage, the drive controller 40 controls opening and closing of the needle valve 17 and controls discharge of the liquid from the liquid discharge head 10. Note that, in a case where the waveform generation circuit can apply a voltage of a sufficient value, the amplification circuit may be omitted.

The waveform generation circuit 41 generates a drive pulse that is a waveform of a voltage, applied to the piezoelectric element 18, changing over time. The waveform generation circuit receives print data input from an external PC or a microcomputer in an apparatus, and generates the drive pulse on the basis of this input data. The waveform generation circuit can change the voltage applied to the piezoelectric element 18 and generate a plurality of drive pulses. As described above, the waveform generation circuit generates the drive pulse, so that the piezoelectric element 18 expands and contracts in accordance with the drive pulse to open and close the needle valve 17.

FIG. 3 is a schematic cross-sectional view perpendicular to the X direction of the liquid discharge head 10.

The nozzle housing 11b is provided with the liquid chamber 16 and holds the nozzle plate 15. The main body housing 11a is provided with a plurality of storages 110 that stores the moving mechanism 58 of the liquid discharge module 70.

A pin fitting hole 111a is formed in an upper portion of the nozzle housing 11b, and a positioning pin 112 is fitted into the pin fitting hole 111a. A positioning hole 111b is formed on a lower surface of the main body housing 11a. When the positioning pin 112 fitted into the pin fitting hole 111a of the nozzle housing 11b is inserted into the positioning hole 111b of the main body housing 11a, the nozzle housing 11b is positioned relative to the main body housing 11a. The nozzle housing 11b is fastened to the main body housing 11a with a screw.

In addition to the needle valve 17 that opens and closes the nozzle 14, the liquid discharge module 70 includes the moving mechanism 58 as a mover provided with the piezoelectric element 18. The piezoelectric element 18 is held by a holder 63.

A protrusion 63a is provided on a proximal end side opposite to the nozzle 14 side of the holder 63, and the protrusion 63a is fitted into a concave portion of the piezoelectric element restriction member 19. The piezoelectric element restriction member 19 includes a screw hole extending in the Y direction. A positioning screw 42 is screwed into the screw hole from the outside of the main body housing 11a.

The positioning screw 42 is inserted into a long hole elongated in the Z direction in an upper end portion of the main body housing 11a. Therefore, the positioning screw 42 is movable by a predetermined length in the Z direction. The positioning screw 42 is fastened in a state in which the piezoelectric element restriction member 19 is positioned in the Z direction. As a result, an upper portion of the piezoelectric element 18 is immovably secured.

The needle valve 17 includes two members: a leading-end member 172 that seals the nozzle 14, and a rear-end member 171, an upper end of which is secured to a leaf spring member 30 of the moving mechanism 58. On the nozzle side of the storage 110 of the main body housing 11a, two bearings 113 for receiving the rear-end member 171 are provided at a predetermined interval in the Z direction (the vertical direction and also the liquid discharge direction). The rear-end member 171 is held in a posture parallel to the Z direction so as to be movable parallel in the Z direction by the two bearings 113. The rear-end member is also referred to as “rear-end member”.

The leading-end member 172 holds an O-ring 22 as a seal that seals between the storage 110 and the liquid chamber 16.

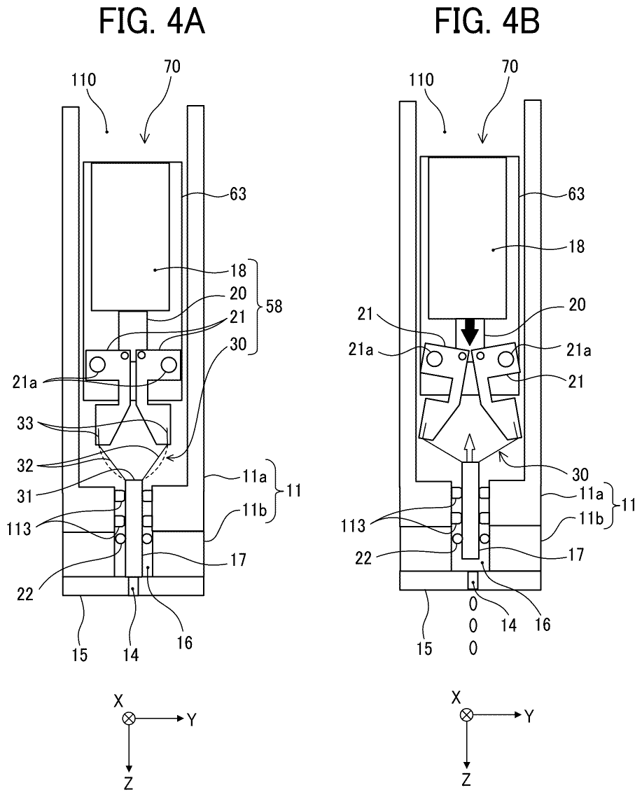

FIGS. 4A and 4B are schematic configuration diagrams illustrating a basic configuration of the liquid discharge module 70.

FIG. 4A is a schematic configuration diagram illustrating a state in which the needle valve 17 closes the nozzle 14, and FIG. 4B is a schematic configuration diagram illustrating a state in which the needle valve 17 opens the nozzle 14.

The liquid discharge module 70 is provided with the needle valve 17 as a valve member that opens and closes the nozzle 14, and the moving mechanism 58. The moving mechanism 58 includes a moving member 20, a pair of arm members 21, and the leaf spring member 30 in addition to the piezoelectric element 18. The moving member 20 includes one end secured to the piezoelectric element 18 and the other end to which a pair of arm members 21 is rotatably attached, and is attached to the holder 63 that holds the piezoelectric element 18 so as to be movable in the Z direction. The pair of arm members 21 is rotatably supported by a support shaft 21a attached to the holder 63.

By bending a sheet metal made of SUS, the leaf spring member 30 forms a valve connection portion 31 connected to the needle valve 17, a pair of inclined portions 32 as elastic deformation portions, and a pair of arm connection portions 33. The needle valve 17 is joined to the valve connection portion 31 with an adhesive, and the inclined portions 32 as the elastic deformation portions extend obliquely upward in the drawing from both ends of the valve connection portion 31. The arm connection portion 33 is fitted into a slit portion provided on the arm member 21 and attached to the arm member 21.

As illustrated in FIG. 4A, when the needle valve 17 closes the nozzle 14 (a state in which the needle valve 17 is at the closed position), the pair of inclined portions 32 of the leaf spring member 30 elastically deforms as indicated by a broken line in the drawing. As a result, a biasing force that presses the needle valve 17 against the nozzle plate 15 is generated.

As indicated by a black arrow in FIG. 4B, when the piezoelectric element 18 is displaced toward the nozzle 14, the moving member 20 moves toward the nozzle and pushes the pair of arm members 21 toward the nozzle. As a result, the pair of arm members 21 rotates about the support shaft 21a as a fulcrum. When the pair of arm members 21 rotates, both ends of the leaf spring member 30 move in a direction separating from each other. As a result, the needle valve 17 is raised to open the nozzle 14, and the liquid is discharged from the nozzle 14 (corresponding to a state in which the needle valve 17 is at the open position to open the nozzle 14).

Since the needle valve 17 and the nozzle plate 15 repeatedly come into and out of contact with each other, a needle leading-end member portion, which is a contact portion of the leading-end member 172 with the nozzle plate 15, and a contact portion of the nozzle plate 15 with the needle valve 17 are worn, or dirt adheres thereto in continuous use. As a result, a discharge state might be deteriorated, or a seal failure might occur and the liquid oozes out of the nozzle 14. Therefore, it is necessary to periodically replace the leading-end member 172 and the nozzle plate 15.

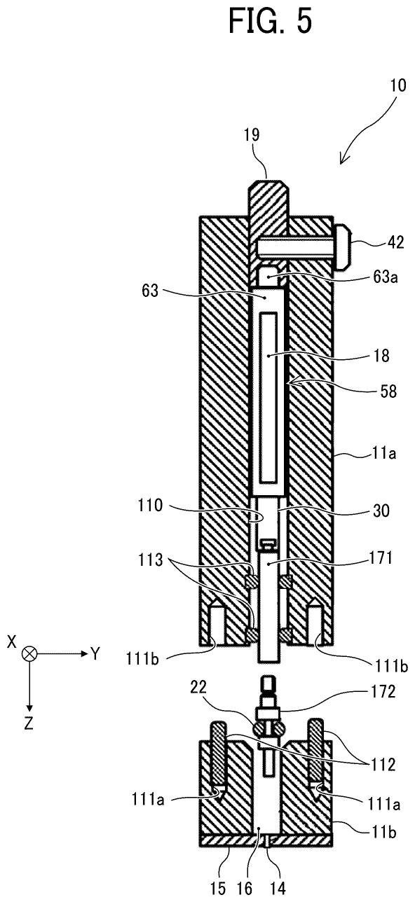

FIG. 5 is a diagram for illustrating replacement of the leading-end member 172 and the nozzle plate 15.

First, the nozzle housing 11b that holds the nozzle plate 15 fastened to the main body housing 11a is removed with a screw to expose the leading-end member 172 of the needle valve 17. Next, the leading-end member 172 the leading-end member of which is worn is removed from the rear-end member 171 and replaced with a new leading-end member 172.

The O-ring 22, which is the seal that seals between the storage 110 and the liquid chamber 16, slides on an inner wall surface of the nozzle housing 11b to be worn when the needle valve 17 is opened and closed. By holding the O-ring 22 by the leading-end member 172, the worn O-ring 22 can be replaced with a new one together with the leading-end member 172. As a result, it is possible to satisfactorily seal between the storage 110 and the liquid chamber 16 over time, and it is possible to satisfactorily suppress the liquid in the liquid chamber 16 from leaking to the storage 110.

After replacement with the new leading-end member 172, the nozzle housing 11b that holds a new nozzle plate 15 is positioned in the main body housing 11a by the positioning pin 112. Thereafter, by being fastened to the main body housing 11a with a screw, the nozzle plate 15 is replaced. By fastening the nozzle plate 15 to the nozzle housing 11b with a screw, the nozzle plate 15 may be configured to be detachable from the nozzle housing 11b, so that only the nozzle plate 15 is replaced.

The housing 11 may be formed of a single member including the liquid chamber 16 and the storage 110, and the nozzle plate 15 may be configured to be detachable from the housing. Specifically, after the positioning pin of the nozzle plate 15 is inserted into the positioning hole of the housing to position, the nozzle plate 15 is fastened to the housing with a screw.

An optimum leading-end member shape, and a material of the leading-end member of the needle valve 17 that can satisfactorily seal are different according to a type and viscosity of the liquid to be discharged, a solid content ratio of fillers contained in the liquid, a shape of the solid content, and a size of the solid content. The optimum leading-end member shape of the needle valve 17 also varies depending on a discharge amount. In the present embodiment, the needle valve 17 includes two members of the leading-end member 172 and the rear-end member 171, and the leading-end member 172 can be easily replaced. Therefore, it is possible to easily change to the leading-end member 172 having a different leading-end member shape. As a result, by changing the leading-end member 172 according to the type and viscosity of the liquid to be discharged, the solid content ratio of the fillers contained in the liquid, the shape of the solid content, the size of the solid content, and the discharge amount, the nozzle 14 can be satisfactorily sealed, and a target discharge amount can be achieved.

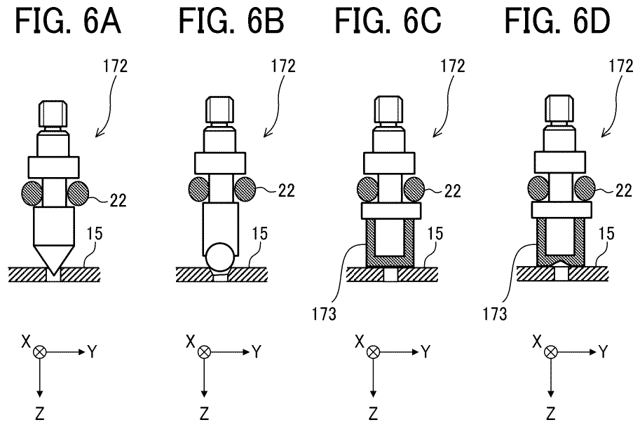

FIGS. 6A to 6D are diagrams illustrating an example of the leading-end member 172 to be replaced.

FIG. 6A illustrates the leading-end member 172 including a conical leading-end member, and FIG. 6B illustrates the leading-end member 172 including a leading-end member fitted with a ball. FIG. 6C illustrates the leading-end member 172 to the leading-end member of which the sealing member 173 made of an elastic member such as resin or rubber is attached, the member having a planar leading-end member shape (lower surface of the sealing member 173). FIG. 6D illustrates the leading-end member 172 to the leading-end member of which the sealing member 173 made of an elastic member such as resin or rubber is attached, the member having a concave leading-end member shape.

The leading-end member 172 having the conical leading-end member shape illustrated in FIG. 6A and the leading-end member 172 having a spherical leading-end member shape illustrated in FIG. 6B come into contact with an edge of the nozzle 14 and a nozzle inner peripheral surface to remove the solid content contained in the liquid to seal. As illustrated in FIGS. 6C and 6D, the leading-end member 172 provided with the sealing member 173 made of an elastic member seals such that the sealing member 173 is elastically deformed, and a non-adhesive portion is not generated by the solid content of the liquid that cannot be removed from a sealing portion between the nozzle 14 and the leading-end member of the needle valve 17.

A user attaches the leading-end member 172 having a leading-end member shape and including a leading-end member material that can satisfactorily seal the nozzle 14 to the rear-end member 171 on the basis of the type and viscosity of the liquid to be discharged, the solid content ratio of the filler contained in the liquid, the shape of the solid content, the size of the solid content, and the discharge amount. This makes it possible to cope with various liquids.

Depending on the type and viscosity of the liquid to be discharged, the solid content ratio of the fillers contained in the liquid, the shape of the solid content, and the size of the solid content, as illustrated in FIG. 6A, there is a case where it is better that the leading-end member of the needle valve 17 be in close contact with the edge of the nozzle 14 to seal. As illustrated in FIG. 6B, there also is a case where it is better to make the shape of the nozzle 14 on the needle valve side conform to the leading-end member shape of the needle valve 17 and bring the leading-end member of the needle valve 17 into close contact with the nozzle inner peripheral surface to seal. There also is an optimum nozzle diameter according to the discharge amount.

In the present embodiment, the nozzle plate 15 can also be replaced, and a combination of the leading-end member 172 that can satisfactorily seal and the nozzle plate (nozzle) can be obtained according to the liquid to be discharged. This makes it possible to further cope with various liquids.

However, when the needle valve 17 includes two members of the leading-end member 172 and the rear-end member 171, and the leading-end member 172 is configured to be easily replaceable, the following problem might occur. That is, there is a problem that the leading-end member 172 might be attached to the rear-end member 171 with a significant shift between the position at the axial center of the leading-end member 172 and the position at the axial center of the rear-end member 171 in a direction orthogonal to the Z direction by an attachment error. There also is a problem that the leading-end member 172 might be attached to the rear-end member 171 in an inclined manner.

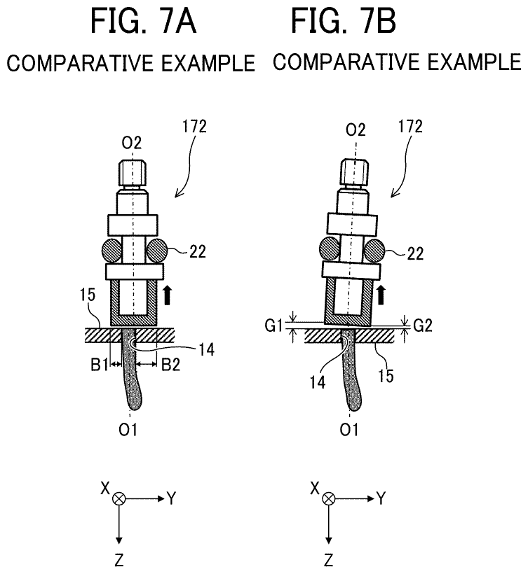

FIG. 7A illustrates a comparative example in which trouble occurs such that the axial center of the leading-end member 172 is shifted in the direction orthogonal to the Z direction relative to the axial center of the rear-end member 171. FIG. 7B illustrates a comparative example in which trouble occurs such that the leading-end member 172 is attached to the rear-end member 171 in an inclined manner.

When the axial center of the leading-end member 172 is shifted in the direction orthogonal to the Z direction relative to the axial center of the rear-end member 171, a position of the axial center O2 of the leading-end member 172 might be shifted relative to the center O1 of the nozzle 14 as illustrated in FIG. 7A.

In this manner, when the position of the axial center O2 of the leading-end member 172 is shifted relative to the center O1 of the nozzle 14, a distance from the nozzle 14 to an end portion of the needle leading-end member becomes non-uniform as illustrated in B1 and B2 in FIG. 7A. Therefore, a fluid resistance becomes non-uniform when a gap between the needle valve leading-end member and a nozzle periphery is narrow immediately after the discharge is started or immediately before the discharge is finished. As a result, as illustrated in FIG. 7A, discharge bending in which the liquid discharged from the nozzle 14 is bent might occur. There also is a trouble of pour draining. When the discharge bending occurs, a pitch variation of droplets might occur at the time of continuous liquid discharge, and a streak might occur in an image.

In a case where the leading-end member 172 is attached to be inclined relative to the rear-end member 171 as illustrated in FIG. 7B, the gap between the needle valve leading-end member and the nozzle periphery becomes non-uniform as indicated by G1 and G2. As a result, as in a case of FIG. 7A, the fluid resistance becomes non-uniform when the gap between the needle valve leading-end member and the nozzle periphery is narrow immediately after the discharge is started or immediately before the discharge is finished. Therefore, even in a case where the leading-end member 172 is attached to be inclined relative to the rear-end member 171, a trouble such as discharge bending and pour draining occurs.

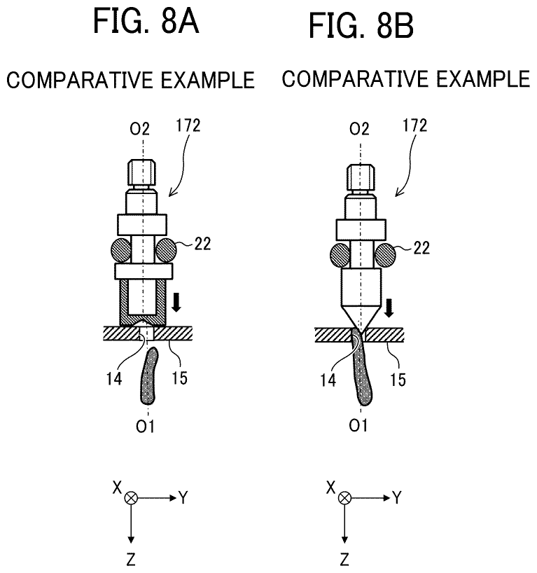

As illustrated in FIG. 8A, a case where the leading-end member shape of the leading-end member 172 is a concave shape, a trouble such as discharge bending due to a difference in distance from the nozzle 14 to the end portion of the needle leading-end member due to the shift between the center O1 of the nozzle 14 and the axial center O2 of the leading-end member 172 is reduced. However, when the needle valve 17 is closed, a discharge draining might be disturbed when discharging the liquid in the concave portion on the needle leading-end member. A part of the liquid might remain in the concave portion on the needle leading-end member and the liquid might flow down from the nozzle 14 after a discharge operation is finished.

As illustrated in FIG. 8B, even in a case where the leading-end member of the leading-end member 172 has a conical shape, if the position of the axial center O2 of the leading-end member 172 is shifted relative to the center O1 of the nozzle 14, the discharge bending might occur at the time of closing.

In any of cases where the leading-end member shape of the needle valve 17 is the planar shape illustrated in FIG. 7, the concave shape illustrated in FIG. 8A, or the conical shape illustrated in FIG. 8B, when the leading-end member 172 is attached to be inclined relative to the rear-end member 171, a portion where an abutting pressure between the needle leading-end member and the nozzle 14 or the nozzle plate 15 is low is generated. As a result, the liquid might leak from the nozzle 14.

Therefore, it is necessary to attach the leading-end member 172 to the rear-end member 171 with high accuracy.

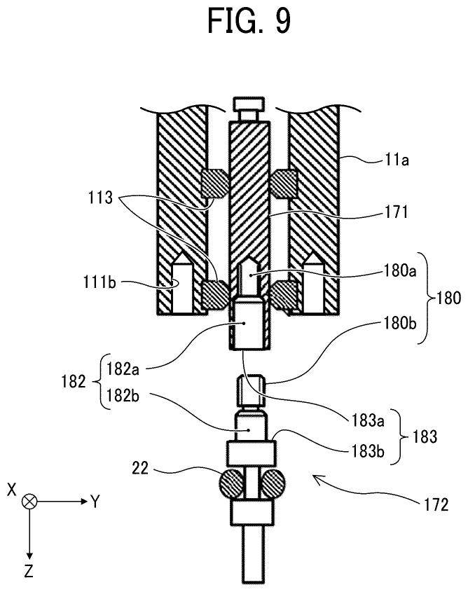

FIG. 9 is a schematic diagram illustrating the vicinity of a connection portion between the leading-end member 172 and the rear-end member 171.

As illustrated in FIG. 9, the needle valve 17 includes a screw portion 180, which also serves as an attachment unit for attaching the leading-end member 172 to the rear-end member 171 and as an axial force generator for generating an axial force, an inlay portion 182, which serves as an axial center restrictor, and an inclination restrictor 183.

The screw portion 180 includes a female screw portion 180a provided on the rear-end member 171 and a male screw portion 180b provided on the leading-end member 172. By fastening the male screw portion 180b to the female screw portion 180a, the leading-end member 172 is attached to the rear-end member 171.

The inlay portion 182 includes a cylindrical fitting hole 182a provided on the rear-end member 171 and a columnar fitting portion 182b provided on the leading-end member 172. By fitting the leading-end member 172 into the fitting hole 182a of the rear-end member 171, the axial center of the leading-end member 172 is accurately restricted relative to the axial center of the rear-end member 171.

The inclination restrictor 183 is a lower end face of the rear-end member 171, and includes a first seat surface 183a perpendicular to the Z direction and a second seat surface 183b extending in a radial direction from a lower end of the fitting portion 182b of the leading-end member 172 and perpendicular to the Z direction. By bringing the second seat surface 183b into close contact with the first seat surface 183a, the inclination of the leading-end member 172 relative to the rear-end member 171 is accurately restricted.

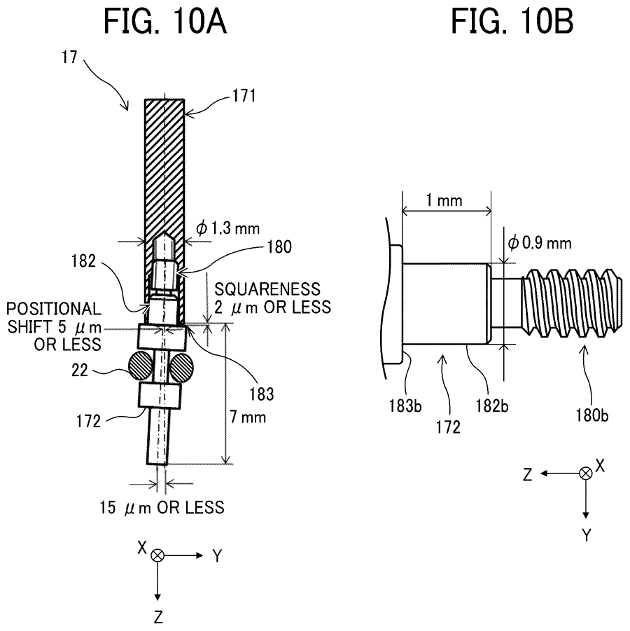

FIGS. 10A and 10B are diagrams for illustrating a dimensional example of the needle valve 17, in which FIG. 10A is a schematic cross-sectional view of the entire needle valve 17, and FIG. 10B is an enlarged view of an upper side of the leading-end member 172 (a rear-end member side of the leading-end member 172).

The needle valve 17 illustrated in FIGS. 10A and 10B has a diameter of 1.3 mm, and the screw portion 180 is a micro screw having a screw size of S0.8. The diameter of the needle valve 17 is the diameter in a case of a minimum mountable nozzle pitch of 2 mm in a valve jet type liquid discharge head including a nozzle row.

In a case where an inner diameter of the nozzle 14 on the needle valve side is 0.3 mm, the leading-end member illustrated in FIG. 6D is used as the leading-end member, and an inner diameter of the leading-end member concave portion is 0.5 mm, it is necessary to suppress the shift between the nozzle center and the axial center of the leading-end member of the needle valve 17 to 50 μm or less.

In addition to attaching accuracy of the leading-end member 172 to the rear-end member 171, there is a following factor that cause the shift between the nozzle center and the center of the leading-end member of the needle valve. That is, there are joining accuracy of 30 μm of the nozzle plate 15 relative to the nozzle housing 11b and assembling accuracy (restricting accuracy of the bearing 113 that receives the rear-end member 171) of 24.5 μm of the rear-end member 171 relative to the main body housing 11a. There also is a center shift error of 19.8 μm when forming the concave portion on the needle leading-end member and positioning accuracy of 19.6 μm when the nozzle housing 11b is attached to the main body housing 11a. A cumulative tolerance (square root of sum of squares) of the shift between the nozzle center and the center of the leading-end member of the needle valve 17 due to these factors is √(30²+24.5²+19.8²+19.6²)=47.7 (μm). Therefore, in order to set the shift between the nozzle center and the center of the leading-end member of the needle valve 17 to 50 μm or less, it is necessary to set the shift between the nozzle center and the center of the leading-end member of the needle valve 17 caused by the attaching accuracy of the leading-end member 172 to the rear-end member 171 to 15 μm (√(50²−47.7²)=15 μm) or less. In the present embodiment, by providing the inlay portion 182 and the inclination restrictor 183, the shift between the nozzle center and the center of the leading-end member of the needle valve 17 caused by the attaching accuracy of the leading-end member 172 to the rear-end member 171 can be made 15 μm or less.

Specifically, an outer diameter of the fitting portion 182b of the inlay portion 182 is set to 0.9 mm, and an inner diameter of the fitting hole 182a of the inlay portion 182 is made larger than the outer diameter of the fitting portion 182b by about 1 to 5 μm. As a result, the axial center of the leading-end member 172 is restricted with an accuracy of 5 μm or less relative to the axial center of the rear-end member 171. A height of the inlay portion 182 (Z direction length) is 1 mm. An outer peripheral surface of the fitting portion 182b and an inner peripheral surface of the fitting hole 182a are simple circular arc surfaces, and the outer diameter of the fitting portion 182b and the inner diameter of the fitting hole can be easily and accurately processed by cutting. Therefore, the fitting hole 182a and the fitting portion 182b can be formed with an accuracy of the gap therebetween of 5 μm or less.

Squareness of the first seat surface 183a and the second seat surface 183b of the inclination restrictor 183 relative to the Z direction is 2 μm or less. As a result, when the second seat surface 183b is in close contact with the first seat surface 183a, the inclination of the leading-end member 172 relative to the rear-end member 171 is restricted at 5 minutes (0.083°) or less. The first seat surface 183a and the second seat surface 183b are flat surfaces orthogonal to the Z direction. Therefore, the first seat surface 183a and the second seat surface 183b can be easily formed with accuracy of squareness of 2 μm or less by cutting and polishing.

As illustrated in FIG. 10A, in a case of the following dimension, when the leading-end member 172 is inclined relative to the rear-end member 171 by 5 minutes (0.083°) or less, the shift between the center of the needle leading-end member and the axial center of the rear-end member is 10 μm or less. That is, a case where a length from the second seat surface 183b to the needle leading-end member (the lower end of the leading-end member) of the leading-end member 172 is 7 mm and an outer diameter of the needle leading-end member is 1 mm.

With the axial center shift in the inlay portion 182, the shift between the center of the needle leading-end member and the axial center of the rear-end member is 15 μm at the maximum. As a result, the shift between the nozzle center and the center of the leading-end member of the needle valve can be set to 50 μm or less, and it is possible to suppress the discharge bending and pour discharge draining due to the shift between the nozzle center and the center of the leading-end member of the needle valve 17.

By making the inner diameter of the fitting hole 182a of the inlay portion 182 larger than the outer diameter of the fitting portion 182b by about 1 to 5 μm, the leading-end member 172 can be moved in an inclined manner in a predetermined range relative to the rear-end member 171. As a result, when the inclination is restricted by the inclination restrictor 183, the leading-end member 172 moves relative to the rear-end member 171 to correct the inclination, and the inclination restrictor 183 accurately restricts the inclination of the leading-end member 172 relative to the rear-end member 171.

When a fastening torque of the screw portion 180, which is the micro screw having the screw size of S0.8, is managed to 0.9 to 1 cN·m, an axial force of about 50 to 60 Nis generated. As a result, the second seat surface 183b can be satisfactorily brought into close contact with the first seat surface 183a of the inclination restrictor 183 by the axial force generated by the screw portion 180. As a result, the inclination of the leading-end member 172 relative to the rear-end member 171 can be accurately restricted by the inclination restrictor 183.

Here, the state in which the second seat surface 183b is in close contact with the first seat surface 183a indicates a stable state in which surface roughness and minute unevenness of the first seat surface 183a and the second seat surface 183b fit by the axial force, and the seat surfaces are in contact with each other at least three or more contact points. A frictional force between the seat surfaces generated by the axial force can prevent the screw portion 180 from being loosened by a load due to an opening/closing operation of the needle valve. As a result, it is possible to prevent close contact between the first seat surface 183a and the second seat surface 183b from being released due to a decrease in axial force and prevent the inclination from being restricted with pour accuracy.

By restricting the inclination of the leading-end member 172 relative to the rear-end member 171 to 5 minutes (0.083°) or less by the inclination restrictor 183, in a case where a diameter of the needle leading-end member is 1 mm, a difference in height of the needle leading-end member (a difference in position in the Z direction) is suppressed to 2 μm or less. As illustrated in FIG. 7B, the discharge bending or sealing failure occurs due to non-uniformity of the gap between the needle valve leading-end member and the nozzle periphery when the difference in height exceeds approximately 5 μm. Therefore, by restricting the inclination of the leading-end member 172 relative to the rear-end member 171 to 5 minutes (0.083°) or less, the difference in height of the end portion of the needle leading-end member in the direction orthogonal to the Z direction can be set to 5 μm or less, and the discharge bending and sealing failure due to the difference in height can be satisfactorily suppressed.

As described with reference to FIG. 8A, in a case where the needle leading-end member shape is concave, an influence by the difference in distance from the nozzle 14 to the end portion of the needle leading-end member due to the shift between the center O1 of the nozzle 14 and the axial center O2 of the leading-end member 172 is small. Therefore, the shift between the center O1 of the nozzle 14 and the axial center O2 of the leading-end member 172 could be allowed up to 15 μm. However, as illustrated in FIG. 7A, in a case where the leading-end member shape of the needle valve is a shape that is greatly affected by the difference in distance from the nozzle 14 to the end portion of the needle leading-end member due to the shift between the center O1 of the nozzle 14 and the axial center O2 of the leading-end member 172, it is necessary to further suppress the axial center shift. Depending on the leading-end member shape of the needle valve, the influence of the difference in distance from the nozzle 14 to the end portion of the needle leading-end member is less than that of the leading-end member shape illustrated in FIG. 8A in some cases, and the axial center shift can be further allowed in some cases. Therefore, the squareness of the second seat surface 183b and the outer diameter dimension of the fitting portion 182b (gap from the fitting hole 182a) are appropriately set according to the leading-end member shape of the needle valve 17.

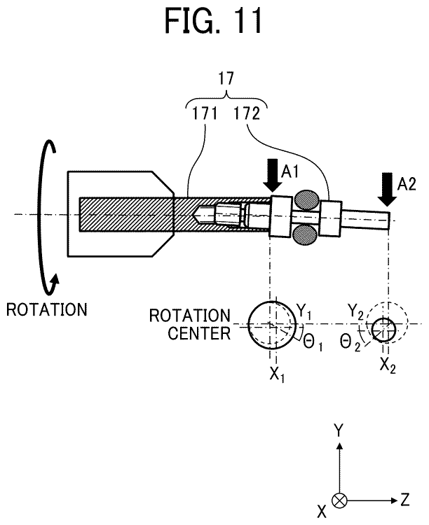

FIG. 11 is a diagram for illustrating a positional shift of the axial center of the leading-end member 172 relative to the axial center of the rear-end member 171 and measurement of the inclination of the leading-end member 172 relative to the rear-end member 171.

A contact portion of the rear-end member 171 with the bearing 113 is chucked, and the needle valve 17 is rotated around the axial center of the rear-end member 171. A micro gauge is brought into contact with a portion indicated by arrow A1 in the drawing, and deflection of a portion of the second seat surface 183b is measured. An amount of positional shift of the axial center of the leading-end member 172 relative to the axial center of the rear-end member 171 can be calculated from the measured deflection amount and rotation angle information.

As for the inclination of the leading-end member 172 relative to the rear-end member 171, the micro gauge is brought into contact with the position of the second seat surface 183b indicated by arrow A1 in the drawing and the needle leading-end member portion indicated by arrow A2 in the drawing, and the deflection amount is measured. The inclination of the leading-end member 172 relative to the rear-end member 171 can be measured from each deflection amount and each rotation angle information.

Also by the screw portion 180, which is the axial force generator, according to an angle of a screw thread, by fastening the screw, a centering function to some extent is provided, and the axial center of the leading-end member can be aligned with the axial center of the rear-end member to some extent. However, even if the screw portion 180 has a high screw grade and high accuracy, the effect is limited, and it is difficult to position on a micron order. Positional shift occurs due to a balance of friction generated when the seat surface comes into contact and a balance of a force at the time of fastening.

In the present embodiment, in addition to the screw portion 180, the inlay portion 182 that restricts the axial center of the leading-end member 172 relative to the axial center of the rear-end member 171 and the inclination restrictor 183 that restricts the inclination of the leading-end member 172 relative to the rear-end member 171 are provided.

The inner peripheral surface of the fitting hole 182a and the outer peripheral surface of the fitting portion 182b of the inlay portion 182 are both circular arc surfaces, and the inner diameter of the fitting hole 182a and the outer diameter of the fitting portion 182b can be accurately formed by simple processing such as cutting. Since each of the first seat surface 183a and the second sear surface 183b of the inclination restrictor 183 is a flat surface, it is possible to accurately form by simple processing such as cutting. This makes it possible to perform accurate attachment with an inexpensive configuration. Screw tolerance can be general screw tolerance, the leading-end member 172 can be easily attached to and detached from the rear-end member 171, and the leading-end member 172 can be easily replaced.

In the needle valve having a dimensional relationship illustrated in FIGS. 10A and 10B, five samples were prepared for each of a comparative example including only the inclination restrictor 183 without the inlay portion 182, and the needle valve of the present embodiment. The shift between the center O1 of the nozzle 14 and the axial center O2 of the leading-end member 172 was measured three times for one sample (15 times in total). An average value±standard deviation (3σ) of the shift between the center O1 of the nozzle 14 and the axial center O2 of the leading-end member 172 of the comparative example was 60±40 μm. In contrast, the average value±standard deviation (3σ) of the shift between the center O1 of the nozzle 14 and the axial center O2 of the leading-end member 172 of the present embodiment was 4±9 μm. In the comparative example without the inlay portion 182, the shift between the center O1 of the nozzle 14 and the axial center O2 of the leading-end member 172 was about 100 μm (99.7% probability) at the maximum, whereas in the present embodiment, the shift was about 13 μm (99.7% probability) at the maximum, and could be suppressed to 15 μm or less.

Even in the comparative example without the inlay portion 182, the inclination of the leading-end member 172 relative to the rear-end member 171 is restricted by the inclination restrictor 183, and the inclination of the leading-end member 172 is restricted to the same extent as in the present embodiment (5 minutes or less, 0.083° or less). Therefore, the shift between the center of the needle leading-end member portion and the nozzle center due to the inclination of the leading-end member 172 is 10 μm or less.

In contrast, the axial center of the leading-end member 172 is restricted relative to the axial center of the rear-end member 171 by the above-described centering function of the screw portion 180 in the comparative example. However, with the centering function of the screw portion 180, it was difficult to position on the micron order, and in the comparative example, the average value±standard deviation (3σ) of the shift between the center O1 of the nozzle 14 and the axial center O2 of the leading-end member 172 was 40=60 μm.

In contrast, in the present embodiment, the inlay portion 182 in which the gap between the fitting portion 182b and the fitting hole 182a is 5 μm or less is provided. Therefore, it is possible to perform positioning on the micron order, and the shift between the center O1 of the nozzle 14 and the axial center O2 of the leading-end member 172 due to the shift of the axial center of the rear-end member 171 relative to the axial center of the leading-end member 172 can be made 5 μm or less. As a result, in the present embodiment including the inlay portion 182, the average value±standard deviation (3σ) of the shift between the center O1 of the nozzle 14 and the axial center O2 of the leading-end member 172 was 4±9 μm, and could be suppressed to 15 μm or less.

By forming the inlay portion 182 with high accuracy and fitting the fitting portion 182b into the fitting hole 182a without any gap, the inlay portion 182 can restrict the inclination of the leading-end member 172 relative to the rear-end member 171 with high accuracy. However, in order to accurately restrict the inclination by the inlay portion 182, it is necessary to increase the length of the inlay portion 182 in the Z direction to some extent and press-fit the fitting portion 182b into the fitting hole 182a. As a result, a large axial force is necessary to screw the leading-end member 172 to the rear-end member 171 while press-fitting the fitting portion 182b into the fitting hole 182a. When the diameter of the needle valve 17 is small, it is difficult to generate a large axial force in the screw portion 180, and attachment is difficult. Since the inner peripheral surface of the fitting hole 182a is worn or enlarged in diameter by repeated attachment and detachment, it is difficult to accurately restrict the inclination by the inlay portion 182 over time.

In the present embodiment, by providing the inclination restrictor 183 separately from the inlay portion 182, the fitting portion 182b may be fitted in the fitting hole 182a with a gap, and the leading-end member 172 can be easily attached to the rear-end member 171. The inclination of the leading-end member 172 relative to the rear-end member 171 can be accurately restricted over time.

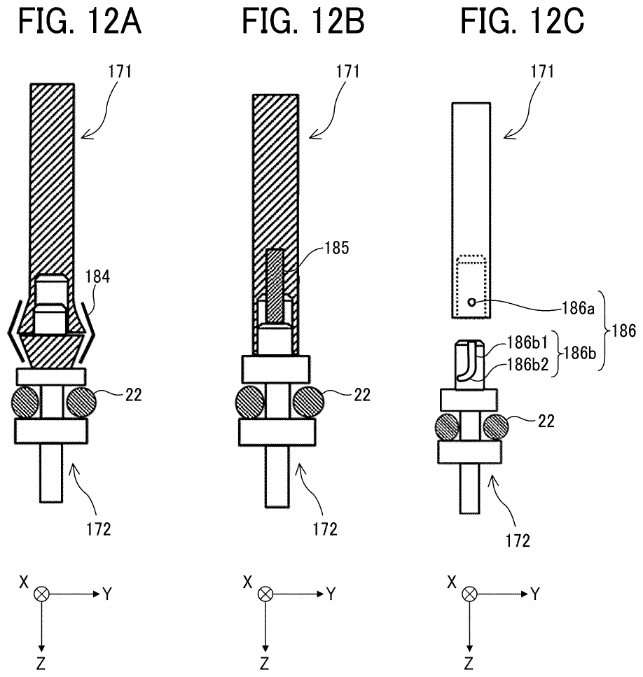

The axial force generator that generates the axial force is not limited to the screw portion 180. For example, as illustrated in FIG. 12A, the leading-end member may be attached to the rear-end member 171 by a heat shrinkable tube 184 used for insulation protection of an electric wire. In a configuration illustrated in FIG. 12A, an outer periphery on the rear-end member side (upper end side) of the leading-end member 172 and an outer periphery on the leading-end member side (lower end side) of the rear-end member 171 have a tapered structure in which the outer diameter increases toward the end portion. These tapered structures are covered with the heat shrinkable tube 184, and hot air is applied to the heat shrinkable tube 184. Then, the heat shrinkable tube 184 shrinks in the Z direction, and the axial force to press the leading-end member 172 against the rear-end member 171 is generated. As a result, the seat surfaces of the inclination restrictor 183 can be brought into close contact with each other.

As illustrated in FIG. 12B, by generating the axial force by a magnetic force, the leading-end member 172 may be attached to the rear-end member 171. As illustrated in FIG. 12B, a magnet 185 is attached to a concave portion on a leading-end member side (lower end side) of the rear-end member 171, and the leading-end member 172 made of a magnetic material such as metal is attracted by the magnetic force of the magnet 185. As a result, the axial force that presses the leading-end member 172 against the rear-end member 171 is generated, and the seat surfaces of the inclination restrictor 183 can be brought into close contact with each other. It is preferable that the magnet 185 is provided so as not to come into contact with the rear-end member (upper end) of the leading-end member 172, and the position of the leading-end member 172 in the vertical direction (Z direction) is restricted by the magnet 185, so that a situation in which the seat surfaces do not come into close contact with each other does not occur. A magnet may be provided on the leading-end member 172.

As illustrated in FIG. 12C, by generating the axial force with a bayonet lock structure, the leading-end member 172 may be attached to the rear-end member 171. A bayonet lock structure unit 186 includes an engagement pin 186a provided on the rear-end member 171 and a lock groove 186b provided on the rear-end member 171. The lock groove 186b includes a guide groove 186b1 extending straight in the Z direction from the rear-end member (upper end) of the leading-end member 172 and a cam groove 186b2 inclined relative to the Z direction. The engagement pin 186a provided on the rear-end member 171 is inserted to a lower end of the guide groove 186b1 of the lock groove 186b. Next, the leading-end member 172 is rotated while being pushed into the rear-end member 171, and the engagement pin 186a is engaged with the cam groove 186b2. By engaging the engagement pin 186a with the cam groove 186b2, the axial force that presses the leading-end member 172 against the rear-end member 171 is generated, and the seat surfaces of the inclination restrictor 183 can be brought into close contact with each other.

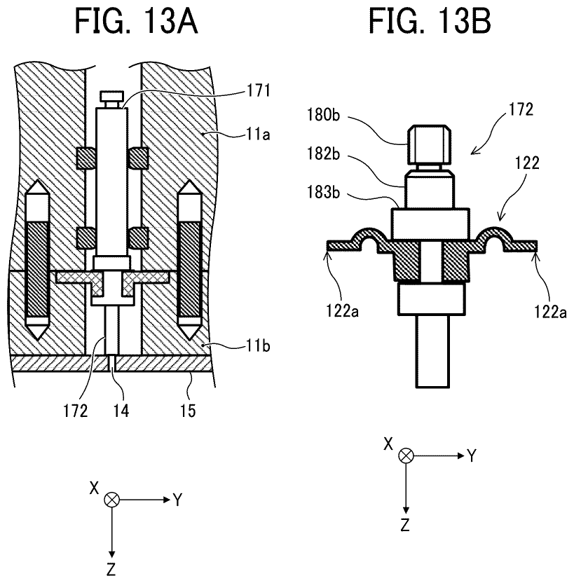

FIGS. 13A and 13B are schematic configuration diagrams illustrating an example in which a diaphragm seal 122 is used as a seal for sealing between the storage 110 and the liquid chamber 16.

The diaphragm seal 122 includes a hole through which the needle valve 17 penetrates at the center, an edge of the hole is secured to the needle valve 17, and an outer end portion of the diaphragm seal 122 is interposed to be secured between the main body housing 11a and the nozzle housing 11b to seal so as to partition the storage 110 and the liquid chamber 16.

Since the diaphragm seal 122 is elastically deformed in the vertical direction along with opening and closing movement of the needle valve 17, cracking or breakage might occur due to fatigue caused by use over time. Therefore, also in a case of the diaphragm seal 122, as illustrated in FIG. 13B, this is preferably configured to be held by the leading-end member 172 and replaced together with the leading-end member 172.

### Modification 1

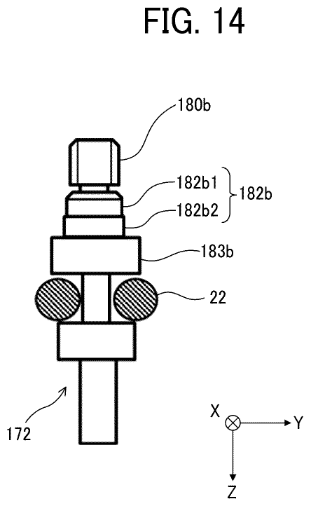

FIG. 14 is a schematic configuration diagram illustrating a first modification of the present embodiment.

In this Modification 1, a fitting portion 182b of a leading-end member 172 has a two-stage configuration including an introduction portion 182b1 and a final fitting portion 182b2 having an outer diameter larger than that of the introduction portion 182b1.

In this Modification 1, the outer diameter of the introduction portion 182b1 is made smaller than an inner diameter of a fitting hole 182a by about 5 to 10 μm. In contrast, the outer diameter of the final fitting portion 182b2 is larger than the inner diameter of the fitting hole 182a by about 1 to 2 μm.

A gap between the introduction portion 182b1 and the fitting hole 182a is 5 μm to 10 μm, and is larger than the gap (1 to 5 μm) of the fitting portion 182b relative to the fitting hole 182a of the present embodiment illustrated in FIGS. 10A and 10B. As a result, the fitting portion 182b can be easily inserted into the fitting hole 182a as compared with the embodiment, and attaching workability of the leading-end member 172 can be improved.

The outer diameter of the final fitting portion 182b2 is larger than the inner diameter of the fitting hole 182a by about 1 to 2 μm, and the final fitting portion 182b2 is lightly press-fitted into the fitting hole 182a. As a result, the axial center of a rear-end member 171 and the axial center of the leading-end member 172 can substantially conform to each other. A screw portion 180 is less likely to be loosened by light press-fitting.

In this Modification 1, when a male screw portion 180b of the leading-end member 172 is screwed into a female screw portion 180a of the rear-end member 171 to some extent, the final fitting portion 182b2 of the fitting portion 182b is lightly press-fitted into the fitting hole 182a. A length of the final fitting portion 182b2 in a Z direction is 100 to 150 μm in a configuration of a micro screw in which an inner diameter of the fitting hole 182a is 0.9 mm and a screw size of the screw portion 180 is S0.8. After the final fitting portion 182b2 of the fitting portion 182b is lightly press-fitted into the fitting hole 182a, a second seat surface 183b of an inclination restrictor 183 immediately comes into close contact with a first seat surface 183a, and screw fastening is completed. In this manner, since the final fitting portion 182b2 is lightly press-fitted into the fitting hole 182a in a final stage of the screw fastening, only the final stage of the screw fastening requires force. As a result, the attaching work of the leading-end member 172 to the rear-end member 171 can be easily performed.

The final fitting portion 182b2 is only slightly fitted into a lower end of the fitting hole 182a, and the inclination of the leading-end member 172 relative to the rear-end member 171 cannot be accurately restricted only by the final fitting portion 182b2. Therefore, even in Modification 1, by providing the inclination restrictor 183 separately from the inlay portion 182, the inclination of the leading-end member 172 relative to the rear-end member 171 can be accurately restricted.

The leading-end member holds the seal at a position closer to a leading-end side than the axial center restrictor and the inclination restrictor in the axial direction.

### Modification 2

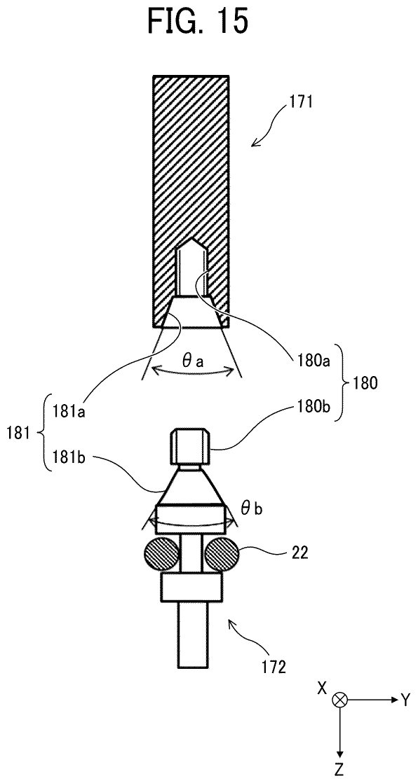

FIG. 15 is a schematic configuration diagram illustrating a second modification of the present embodiment.

As illustrated in FIG. 15, in the second modification, a needle valve 17 includes a screw portion 180, which also serves as an attachment unit and as an axial force generator, and a tapered portion 181. The tapered portion 181 accurately restricts the axial center of a leading-end member 172 relative to the axial center of a rear-end member 171, and accurately restricts inclination of the leading-end member 172 relative to the rear-end member 171. That is, the tapered portion 181 serves as both an axial center restrictor and an inclination restrictor.

As illustrated in FIG. 15, the tapered portion 181 includes a first tapered surface portion 181a provided on the rear-end member 171 and a second tapered surface portion 181b provided on the leading-end member 172. The first tapered surface portion 181a has a substantially mortar shape an inner diameter of which increases toward a lower side (nozzle side), and the second tapered surface portion 181b has a substantially conical shape an outer diameter of which increases toward the lower side.

When a male screw portion 180b of the leading-end member 172 is screwed into a female screw portion 180a of the rear-end member 171, the second tapered surface portion 181b comes into close contact with the first tapered surface portion 181a. Since the second tapered surface portion 181b is in close contact with the first tapered surface portion 181a, the axial center of the leading-end member 172 is accurately restricted relative to the axial center of the rear-end member 171. The inclination of the leading-end member 172 relative to the rear-end member 171 is accurately restricted.

In this Modification 2, as compared with the configuration including the inlay portion 182 of the embodiment, (a portion in which the male screw portion 180b and the second tapered surface portion 181b are formed of) the leading-end member 172 can be easily inserted into a concave portion (portion in which the female screw portion 180a and the first tapered surface portion 181a are formed) provided on a leading-end member side of the rear-end member 171. The first tapered surface portion 181a can guide the male screw portion 180b to the female screw portion 180a. As a result, the leading-end member 172 can be easily attached to the rear-end member 171.

Damage (wear, distortion) to the needle valve 17 can be suppressed as compared with a case where the axial center of the leading-end member 172 is accurately restricted relative to the axial center of the rear-end member 171 by light press-fitting of Modification 1. As a result, it is possible to suppress a decrease in restriction accuracy due to repeated attachment and detachment of the leading-end member 172. Since each of the first tapered surface portion 181a and the second tapered surface portion 181b is a surface inclined relative to a Z direction, dirt adhered to the tapered surface portion is likely to fall. Therefore, as compared with a configuration in which seat surfaces orthogonal to the Z direction are brought into close contact with each other to perform the inclination restriction with high accuracy, there is an advantage that the accuracy of the inclination restriction due to the adhesion of dirt is less likely to decrease, and the dirt is easily removed by cleaning.

In contrast, the configuration of the embodiment in which the inlay portion 182 and the inclination restrictor 183 are provided has an advantage that high accuracy can be obtained by simple processing and manufacturing cost can be reduced as compared with the tapered portion.

### Modification 3

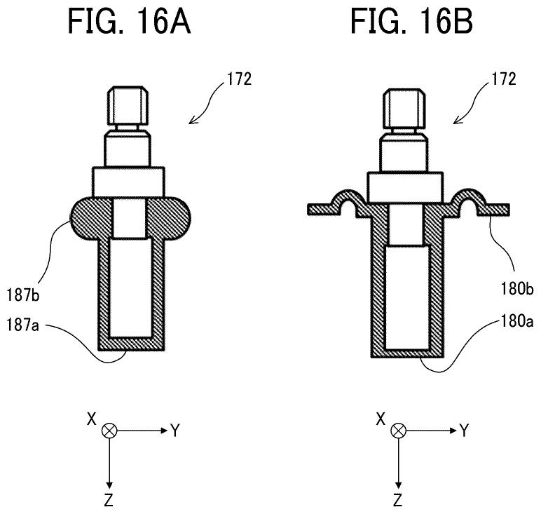

FIGS. 16A and 16B are schematic configuration diagrams illustrating a third modification of the present embodiment.

As illustrated in FIGS. 16A and 16B, in Modification 3, a seal portion 187b for sealing between a storage 110 and a liquid chamber 16 and a sealing portion 187a for sealing a nozzle 14 are integrally molded with a leading-end member 172. The seal portion 187b of the leading-end member 172 illustrated in FIG. 16A is an O-ring type that abuts an inner wall surface of a housing 11 and slides on the inner wall surface of the housing. In contrast, the seal portion 187b of FIG. 16B is a diaphragm type an end portion of which is interposed between a main body housing 11a and a nozzle housing 11b.

The seal portion 187b and the sealing portion 187a are integrally molded with the leading-end member by insert-molding rubber and resin using a main body of the leading-end member 172 made of metal as a cored bar. Since the seal portion 187b is integrally molded with the main body of the leading-end member 172, the center of the seal portion 187b can conform to the center of the leading-end member 172 with high accuracy, and an abutting pressure with the housing inner wall surface can be made uniform. As a result, it is possible to suppress a variation in sliding resistance relative to the housing inner wall surface and a variation in elastic deformation of the seal portion, to satisfactorily open and close the needle valve, and to satisfactorily seal with the housing inner wall surface.

For example, even in the leading-end member having a configuration not including a sealing member 173 illustrated in FIGS. 6A and 6B, the seal portion 187b for sealing between the storage 110 and the liquid chamber 16 may be integrally molded with the main body of the leading-end member 172 by insert molding. Even in this case, the variation in sliding resistance relative to the housing inner wall surface and the variation in elastic deformation of the seal portion can be suppressed.

However, in a case where the nozzle is sealed with the main body of the leading-end member made of metal, progress of wear of the needle leading-end member is slower than progress of wear of the seal portion made of rubber or resin. Therefore, as for the leading-end member not including the sealing portion made of rubber or resin on the needle leading-end member, it is preferable to configure that an O-ring 22 and a diaphragm seal 122 are held and only the O-ring 22 and the diaphragm seal 122 can be replaced.

The liquid discharge head includes: a liquid chamber to store a liquid discharged from the nozzle; a mover storage to store the mover; a first seal to seal a portion between the liquid chamber and the mover storage; and a second seal at a leading end of the leading-end member to seal the nozzle, and the first seal and the second seal are formed as a single member.

### Modification 4

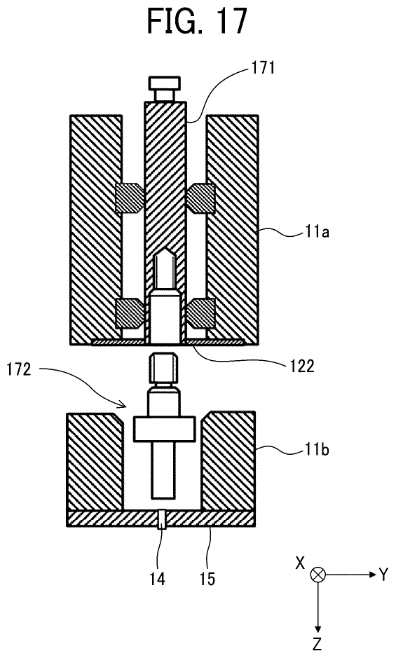

FIG. 17 is a schematic configuration diagram illustrating a fourth modification of the present embodiment.

As illustrated in FIG. 17, in this Modification 4, a diaphragm seal 122 for sealing between a storage 110 and a liquid chamber 16 is attached to a lower end of a main body housing 11a. An edge of a hole through which a needle valve 17 penetrates of the diaphragm seal 122 is interposed to be secured by a leading-end member 172 and a rear-end member 171. Accordingly, when the leading-end member 172 is attached to the rear-end member 171, the edge of the hole through which the needle valve 17 penetrates of the diaphragm seal 122 can be secured to the needle valve. Therefore, the diaphragm seal 122 is easily secured to the needle valve 17.

The liquid discharge head includes: a housing to house the needle valve; a mover storage to store the mover; a liquid chamber to store a liquid discharged from the nozzle; a diaphragm seal having a through hole through which the needle valve is penetrable. The diaphragm seal has: a peripheral portion secured to the housing; and an inner edge portion of the through hole secured between the leading-end member and the rear-end member of the needle valve, and the diaphragm seal seals a portion between the liquid chamber and the mover storage.

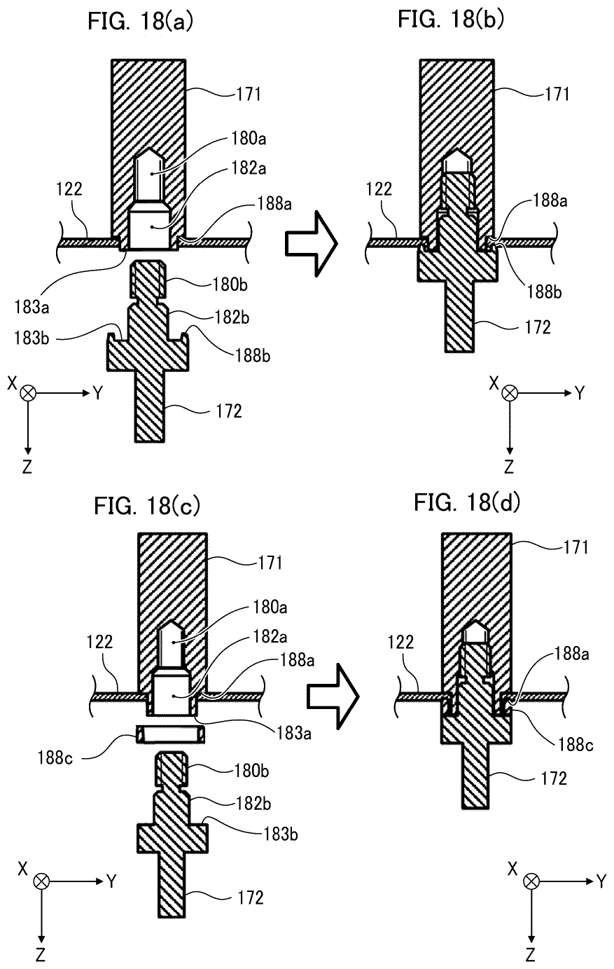

FIGS. 18(a) to 18(d) are diagrams illustrating an example of a diaphragm interposing structure of the needle valve 17.

In FIGS. 18(a) and 18(b), a ring-shaped cutout 188a is provided on an end portion of a first seat surface 183a of the rear-end member 171, and a ring-shaped protrusion 188b is provided on an end portion of a second seat surface 183b of the leading-end member 172.

The edge of the hole, through which the needle valve 17 penetrates, of the diaphragm seal 122 is located in the cutout 188a on the end portion of the first seat surface 183a, and a position of the hole, through which the needle valve 17 penetrates, of the diaphragm seal 122 is restricted. As illustrated in FIG. 18(b), when the leading-end member 172 is attached to the rear-end member 171, the edge of the hole through which the needle valve 17 penetrates of the diaphragm seal 122 is crushed by the ring-shaped protrusion 188b. As a result, the edge of the hole through which the needle valve 17 penetrates of the diaphragm seal 122 is interposed to be secured by the leading-end member 172 and the rear-end member 171, and sealing is performed.

In FIGS. 18(c) and 18(d), the edge of the hole through which the needle valve 17 penetrates of the diaphragm seal 122 is crushed by a ring-shaped washer 188c, and the edge of the hole is interposed between the leading-end member 172 and the rear-end member 171 via the washer 188c to perform sealing.

In a configuration illustrated in FIGS. 18(a) and 18(b), when the leading-end member 172 is attached to the rear-end member 171 by screwing, the protrusion 188b rotates together with the leading-end member 172. Therefore, a force in a rotation direction is applied to the diaphragm seal 122, and the diaphragm seal 122 might be twisted. In contrast, as illustrated in FIGS. 18(c) and 18(d), by using the washer 188c, it is possible to suppress the washer 188c from rotating together with the leading-end member 172 when the leading-end member 172 is screwed. As a result, it is possible to suppress the diaphragm seal 122 from being twisted.

### Modification 5

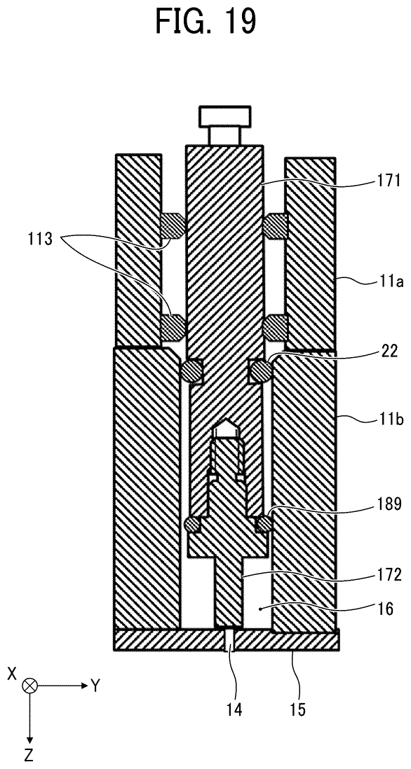

FIG. 19 is a schematic configuration diagram illustrating a fifth modification of the present embodiment.

As illustrated in FIG. 19, in Modification 5, a connection portion between a leading-end member 172 and a rear-end member 171 is located in a liquid chamber 16.

As illustrated in FIG. 19, by configuring such that the connection portion between the leading-end member 172 and the rear-end member 171 is located in the liquid chamber 16, a length of the leading-end member 172 can be shortened. As a result, it is possible to suppress positional shift between the axial center of the needle leading-end member and the center of the nozzle 14 when the leading-end member 172 is inclined relative to the rear-end member 171.

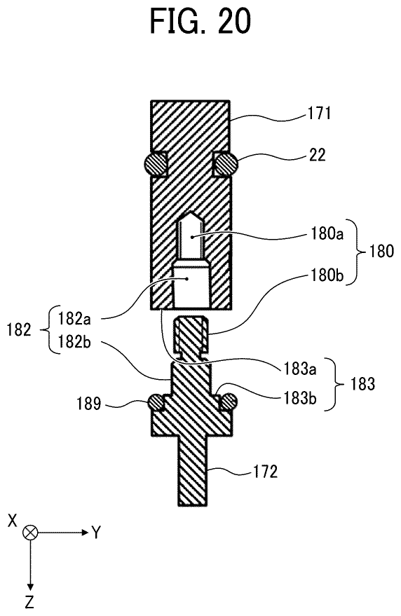

FIG. 20 is a schematic diagram of a needle valve 17 in a configuration of Modification 5.

As illustrated in FIG. 20, an O-ring 22 that seals between the liquid chamber 16 and a storage 110 is held by the rear-end member 171. A ring-shaped cutout is formed on an end portion of a second seat surface 183b of the leading-end member 172, and a valve connection seal 189 (O-ring) is held by the cutout. When the leading-end member 172 is attached (screwed) to the rear-end member 171, the valve connection seal 189 abuts a first seat surface 183a of the rear-end member 171 and is crushed. As a result, the connection portion between the leading-end member 172 and the rear-end member 171 is sealed by the valve connection seal 189.

In this manner, since the connection portion between the leading-end member 172 and the rear-end member 171 is sealed with the valve connection seal 189, it is possible to prevent liquid in the liquid chamber 16 from entering a screw portion 180, an inlay portion 182, and an inclination restrictor 183. As a result, it is possible to suppress dirt of the screw portion 180, the inlay portion 182, and the inclination restrictor 183, and the leading-end member 172 can be easily attached to and detached from the rear-end member 171.

The liquid discharge head 10 described above is of a valve jet type, and can discharge a highly viscous liquid or a large droplet (having a diameter of several tens to several hundred μm) toward a discharge target at a distance (several tens mm ahead). The nozzle diameter can be increased, and liquid containing a material having a large particle diameter can be satisfactorily discharged. In this manner, since liquid having high viscosity can be discharged, the liquid discharge head 10 described above is suitable for painting a vehicle body of a vehicle or a truck, a body of an aircraft, a wall surface of a building, and a road surface, and printing an image. This can also be suitably used for forming an electrode of a lithium ion battery mounted on a vehicle body.

Hereinafter, an example of a liquid discharge apparatus including the above-described liquid discharge head 10 will be described.

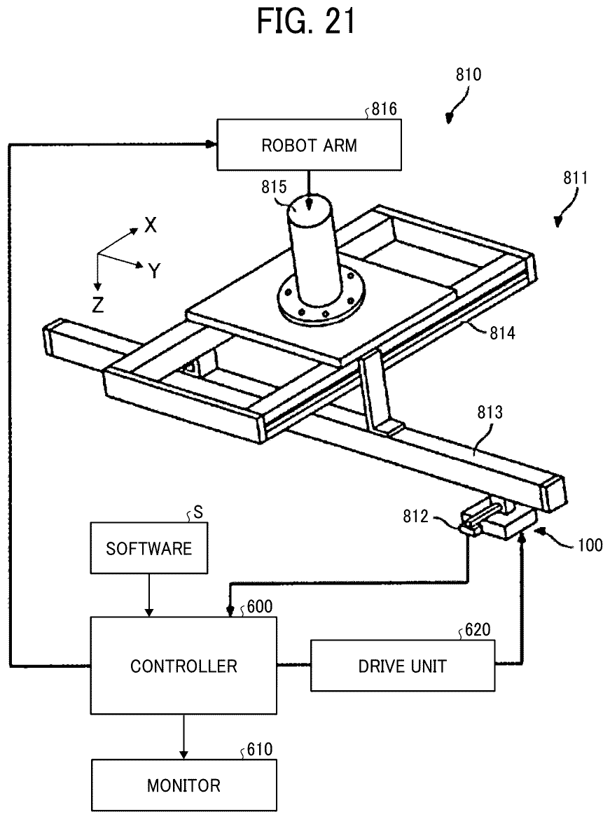

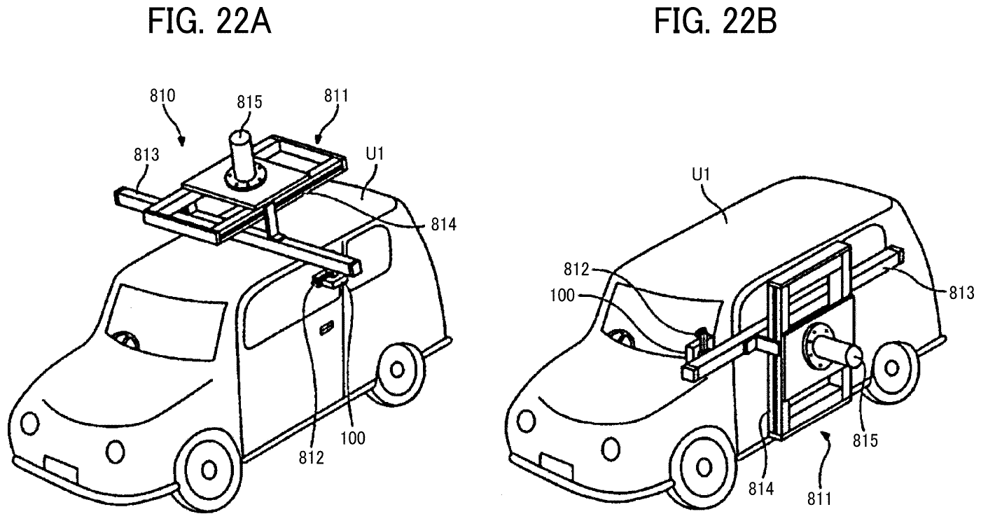

FIG. 21 is a schematic configuration diagram of an inkjet printer 810 as a liquid discharge apparatus, and FIGS. 22A and 22B are perspective views illustrating an arrangement example of the inkjet printer 810 relative to an automobile U1.

As illustrated in FIG. 21, the inkjet printer 810 is provided with a liquid discharge unit 100 provided with a liquid discharge head, and a camera 812 as an image capturing unit arranged in the vicinity of the liquid discharge unit 100. An X-Y table 811 as a scan moving mechanism that moves the liquid discharge unit 100 and the camera 812 in the X direction and the Y direction is provided.

The inkjet printer 810 is provided with a controller 600. The controller 600 operates the X-Y table 811 on the basis of image editing software S for editing an image captured by the camera 812 and a control program set in advance to discharge ink from the liquid discharge unit 100 and control printing on a printed surface. The inkjet printer 810 is provided with a drive unit 620 that positions the camera 812 and the liquid discharge unit 100 at predetermined positions on the basis of the control from the controller 600 to perform an operation such as image capturing and printing. The X-Y table 811 serves as a scanner to move the liquid discharge head. Thus, the liquid discharge apparatus includes the liquid discharge head and the scanner to move the liquid discharge head.

The liquid discharge unit 100 is provided with a plurality of liquid discharge heads that discharges ink toward a surface to be coated of the automobile U1 (refer to FIGS. 22A and 22B) as an object to be coated. Note that, the term “ink” as used herein also includes “paint”. A nozzle surface of the liquid discharge head is parallel to an X-Y plane formed by movement of the X-Y table 811, and ink dots discharged from each nozzle are discharged in the Z direction perpendicular to the X-Y plane.

Each of the plurality of liquid discharge heads included in the liquid discharge unit 100 is coupled to an ink tank of a predetermined color, and the ink tank is pressurized by a pressurizer. The ink in the ink tank is supplied from the supply port 12 (refer to FIG. 1) of the liquid discharge head and ejected from the recovery port 13 (refer to FIG. 1) of the liquid discharge head. The ink ejected from the recovery port 13 is recovered in the ink tank.

When a distance between the nozzle surface of the liquid discharge head and the print surface of the automobile U1 is about 20 cm, the ink dots can be discharged onto the print surface of the automobile U1 without any problem.

The X-Y table 811 is provided with a Y-axis rail 813 formed with a linear moving mechanism, and an X-axis moving mechanism 814 that moves the Y-axis rail 813 in the X direction while holding the Y-axis rail 813 with two arms.

The liquid discharge unit 100 and the camera 812 to be described later are attached to a slider held by the Y-axis rail 813. The X-axis moving mechanism 814 is provided with a shaft 815, and the shaft 815 is held by a robot arm 816. The robot arm allows the liquid discharge unit 100 to be freely arranged at a predetermined position where printing is to be performed on the automobile U1.

For example, this can be arranged above the automobile U1 as illustrated in FIG. 22A, or can be arranged at a lateral position of the automobile U1 as illustrated in FIG. 22B by the robot arm 816. Note that, the operation of the robot arm 816 is controlled on the basis of a program stored in advance in the controller 600.

The camera 812 is arranged on the slider of the Y-axis rail 813 in the vicinity of the liquid discharge unit 100, and captures images in a predetermined range of the printed surface of the automobile U1 at constant minute intervals while moving in the X-Y direction. The camera 812 is a so-called digital camera, and as described above, specifications of a lens that can capture a plurality of subdivided images in a predetermined range of the printed surface, and specifications of resolution are appropriately selected. The plurality of subdivided images of the printed surface are continuously and automatically captured by the camera 812 according to a program provided in advance in the controller 600.

The controller 600 is provided with a storage device that records and stores various programs, data of captured images, and data of images to be printed, and a central processing unit that executes various types of processing according to the programs. The controller 600 is configured by a so-called microcomputer provided with an input device such as a keyboard and a mouse, and a DVD player as necessary.

The inkjet printer 810 is further provided with a monitor 610, and displays input information to the controller 600 and a processing result by the controller 600.

The controller 600 performs image processing on a plurality of pieces of subdivided image data captured by the camera 812 using image processing software, and generates a composited print surface obtained by projecting the printed surface of the automobile U1, which is not a flat surface, onto a flat surface to be described later. The controller 600 edits an image to be drawn to generate an edited image to be drawn in the following manner. That is, this superimposes the image to be drawn, which is the image that should be printed so as to be continuous to the image already printed on the printed surface on the composited print surface, and edits the image to be drawn so as to be continuous to an edge portion of the printed image.

For example, as for the image to be drawn, by editing (deforming) the image to be drawn so as to be aligned with the composited print surface such that a non-printed region is not formed between the same and an adjacent image, the edited image to be drawn is generated. Printing is actually performed by the liquid discharge unit 100 on the basis of the edited image to be drawn. As a result, the print image can be printed without a gap from the printed print image. Note that, the operation of capturing the plurality of subdivided images by the camera 812 and printing by discharging ink from the nozzle of each liquid discharge head of the liquid discharge unit 100 is performed by the drive unit 620 of which operation is controlled by the controller 600.

Next, an electrode manufacturing apparatus will be described as another example of a liquid discharge apparatus provided with the liquid discharge head of the present embodiment.

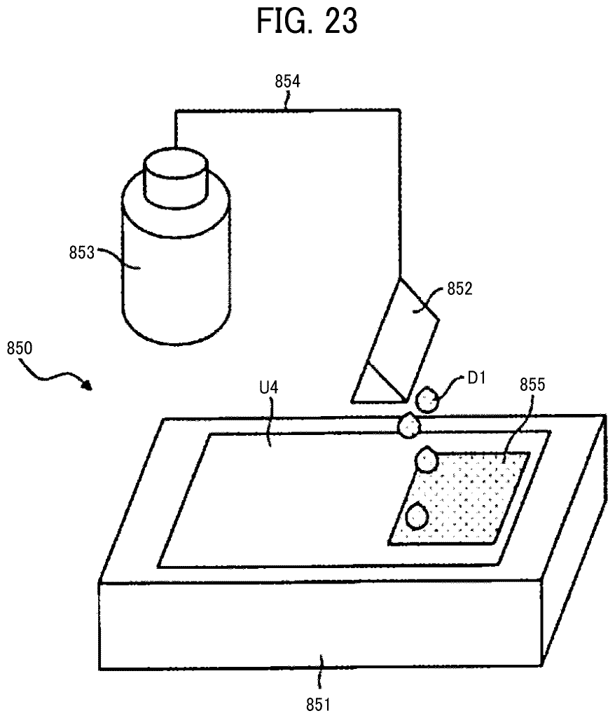

FIG. 23 is a schematic perspective view illustrating an example of an electrode manufacturing apparatus 850.

The electrode manufacturing apparatus 850 illustrated in FIG. 23 is an apparatus that manufactures a negative electrode used for an electrochemical element such as a primary battery, a secondary battery, a capacitor, or a condenser, for example. The electrode manufacturing apparatus 850 is provided with a liquid discharge unit 852 including the liquid discharge head 10 of the present embodiment, and discharges liquid to a negative electrode substrate U4 on a stage 851 using an inkjet method.

A liquid tank 853 stores a liquid composition D1 for forming a negative electrode mixture layer 855, and supplies the liquid composition D1 from the liquid tank 853 to the liquid discharge unit 852 via a tube 854.

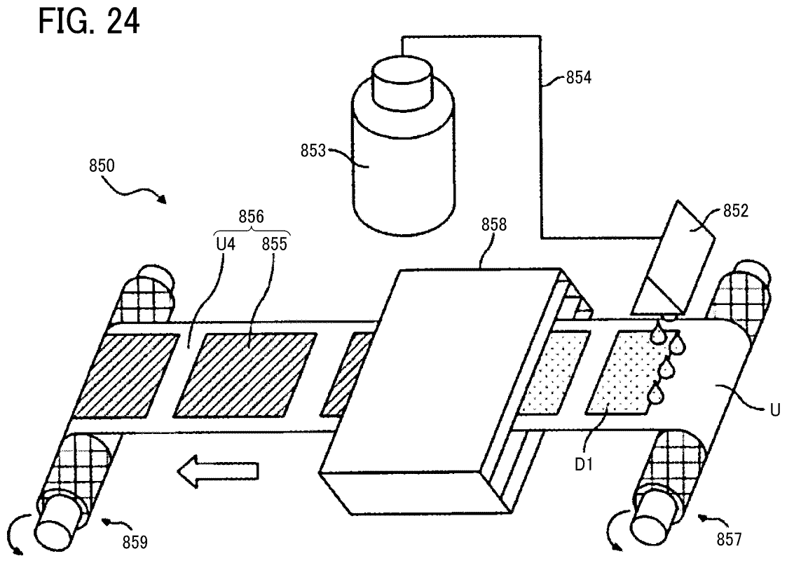

FIG. 24 is a schematic perspective view illustrating another example of the electrode manufacturing apparatus 850.

The electrode manufacturing apparatus 850 illustrated in FIG. 24 winds a strip-shaped negative electrode substrate U4 made of stainless steel and copper around a cylindrical core, and loads the same onto a feeding roller 857 and a winding roller 859 with a surface on which the negative electrode mixture layer 855 is to be formed facing upward. The feeding roller 857 and the winding roller 859 rotate counterclockwise, and the negative electrode substrate U4 moves from right to left in the drawing.

The liquid tank 853 stores the liquid composition D1 for forming the negative electrode mixture layer 855, and supplies the liquid composition D1 from the liquid tank 853 to the liquid discharge unit 852 via the tube 854. The liquid discharge unit 852 is installed above the negative electrode substrate U4 between the feeding roller 857 and the winding roller 859. A plurality of liquid discharge units 852 may be installed in a direction substantially parallel or perpendicular to a conveyance direction of the negative electrode substrate U4.

The feeding roller 857 and the winding roller 859 convey the negative electrode substrate U4 on which the liquid composition D1 is placed to a dryer 858. As a result, the liquid composition D1 on the negative electrode substrate U4 is dried by the dryer 858 to become the negative electrode mixture layer 855, and a negative electrode 856 obtained by binding the negative electrode mixture layer 855 on the negative electrode substrate as the negative electrode substrate U4 is formed. Thereafter, the negative electrode 856 is cut into a desired size by punching.

The dryer 858 is not particularly limited as long as this does not come into direct contact with the liquid composition D1, and can be appropriately selected. Examples thereof include a resistance heater, an infrared heater, and a fan heater, for example. The dryer 858 may be installed on either the upper or lower side of the negative electrode substrate U4. A plurality of dryers 858 may be provided.

In the above description, the apparatus for manufacturing the negative electrode used for the electrochemical element has been described as an example, but it is of course possible to apply to an apparatus for manufacturing a positive electrode. In a case of manufacturing the positive electrode, the negative electrode substrate is replaced with a positive electrode substrate, and the liquid composition D1 for forming the negative electrode mixture layer 855 is replaced with a liquid composition for forming a positive electrode mixture layer. The configuration other than the electrode mixture layer in the electrochemical element is not particularly limited, and a known configuration can be appropriately selected, and examples thereof include a positive electrode, a negative electrode, and a separator, for example.

By providing an external tank and controlling a valve, it is also possible to supply the liquid composition D1 from the external tank 860 to the liquid tank 853 when the liquid composition D1 in the liquid tank 853 is reduced.

Although preferred embodiments of the present embodiment have been described above, the present embodiment is not limited to such specific embodiments, and unless particularly limited in the above description, various modifications and changes can be made without departing from the scope of the gist of the present embodiment recited in claims.

In the above description, an example in which the needle valve 17 is opened and closed by the piezoelectric element 18 has been described. However, the present embodiment is not limited thereto, and the needle valve 17 may be opened and closed by pneumatic pressure or hydraulic pressure. In this case, the drive pulse generated by the drive controller 40 is a drive waveform for driving the pressurizing mechanism by pneumatic pressure or hydraulic pressure with a set pressure.

In the present application, the “liquid discharge apparatus” is an apparatus provided with the liquid discharge head or the liquid discharge unit obtained by integrating functional parts and mechanisms with the liquid discharge head, the apparatus that drives the liquid discharge head to discharge the liquid. The integration includes a combination in which the liquid discharge head and the functional parts and mechanisms are secured to each other through fastening, bonding, and engaging, and a combination in which one is movably held by the other. The liquid discharge head may be detachably attached to the functional parts and mechanisms.

There also is the liquid discharge unit in which the liquid discharge head and the head tank are integrated and the liquid discharge unit in which the liquid discharge head and the head tank are connected to each other with a tube to be integrated. Here, a unit including a filter may be added between the liquid discharge head and the head tank of the liquid discharge unit.

Examples of the liquid discharge unit include the unit in which the liquid discharge head and a carriage are integrated, and the liquid discharge unit in which the liquid discharge head, the carriage, and the scan moving mechanism are integrated. Examples of the liquid discharge unit include the liquid discharge unit in which the liquid discharge head is movably held by a guide member that forms a part of the scan moving mechanism, and the liquid discharge head and the scan moving mechanism are integrated.

Examples of the liquid discharge unit include the liquid discharge unit in which a cap member as a part of a maintenance recovery mechanism is secured to the carriage to which the liquid discharge head is attached, and the liquid discharge head, the carriage, and the maintenance recovery mechanism are integrated. Examples of the liquid discharge unit include the liquid discharge unit in which a tube is connected to the liquid discharge head to which the head tank or flow path parts are attached, and the liquid discharge head and a supply mechanism are integrated. Liquid in a liquid reservoir source is supplied to the liquid discharge head through this tube.

The scan moving mechanism includes a guide member single body. The supply mechanism includes a tube single body and a loading unit single body.

The “liquid discharge apparatus” includes not only an apparatus that can discharge liquid to a material on which liquid can adhere but also an apparatus that discharges liquid toward gas or into liquid.

The “liquid discharge apparatus” may include a unit regarding feeding, conveyance, and ejection of a material on which liquid can adhere, a pretreatment apparatus, and a post-treatment apparatus.

The “liquid discharge apparatus” may be, for example, an image forming apparatus to form an image on a sheet by discharging ink, or a stereoscopic fabrication apparatus (three-dimensional fabrication apparatus) to discharge fabrication liquid to a powder layer in which powder material is formed in layers to fabricate a stereoscopic fabrication object (three-dimensional fabrication object).

The “liquid discharge apparatus” is not limited to an apparatus to discharge liquid to visualize meaningful images, such as letters or figures. For example, an apparatus to form meaningless images or fabricate three-dimensional images is also included.

The “material on which liquid can adhere” is the above-described liquid discharge target, and means a material to which the liquid can at least temporarily adhere and to which the liquid adheres and adheres, a medium to which the liquid adheres and permeates. Specific examples include recording media such as a sheet, recording paper, a recording sheet, a film, and a cloth, electronic components such as an electronic substrate and a piezoelectric element, and media such as a powder layer, an organ model, and a testing cell, and include any material on which liquid can adhere, unless particularly limited.

Examples of the “material on which liquid can adhere” include any materials on which liquid can adhere even temporarily such as paper, thread, fiber, fabric, leather, metal, plastic, glass, wood, and ceramic.

The “liquid discharge apparatus” may be an apparatus in which the head unit and the material on which the liquid can adhere move relative to each other; however, the liquid discharge apparatus is not limited to this. Specific examples include a serial type apparatus that moves the head unit, and a line type apparatus that does not move the head unit.

Examples of the “liquid discharge apparatus” further include a treatment liquid applying apparatus to discharge treatment liquid to a sheet for applying the treatment liquid to a sheet surface to reform the sheet surface. There also is an injection granulation apparatus for injecting composition liquid in which raw materials are dispersed in a solution through a nozzle hole to granulate fine particles of the raw material.

According to the present embodiment, the leading-end member can be accurately attached to the rear-end member.

The above-described embodiments are limited examples, and the present disclosure includes, for example, the following aspects having advantageous effects.

### Aspect 1

According to Aspect 1, in a liquid discharge head including a needle valve 17 that opens and closes a nozzle 14, and a mover such as a moving mechanism 58 that moves the needle valve 17 between a closed position at which the nozzle 14 is closed and an open position at which the nozzle 14 is opened, the needle valve 17 including a rear-end member 171 coupled to the mover and a leading-end member 172 attached to the rear-end member 171, an axial force generator such as a screw portion 180 that generates an axial force for making the leading-end member 172 abut the rear-end member 171 is included, the needle valve 17 includes, in addition to the axial force generator, an axial center restrictor such as an inlay portion 182 that restricts a position of an axial center of the leading-end member 172 relative to an axial center of the rear-end member 171, and an inclination restrictor 183 that restricts inclination of the leading-end member 172 relative to the rear-end member 171.

By generating the axial force by the axial force generator such as the screw portion 180 and cause the leading-end member 172 to contact with the rear-end member 171, the leading-end member 172 can be attached to the rear-end member 171 without play. For example, the screw portion disclosed in Japanese Patent No. 3247123 is used as the axial force generator, and the axial force is generated by screwing with the screw portion, so that the leading-end member can be attached to the rear-end member without play relative to the rear-end member.

However, it is difficult to accurately process a thread shape of the screw of the screw portion and the pitch of the screw. As a result, the leading-end member might be attached to the rear-end member in a state in which the axial center of the leading-end member is significantly shifted in a direction orthogonal to the axial direction relative to the axial center of the rear-end member, or the leading-end member is inclined relative to the rear-end member. In this manner, in the screw portion as the axial force generator, the position of the axial center of the leading-end member relative to the axial center of the rear-end member and the inclination of the leading-end member relative to the rear-end member cannot be accurately restricted, and there has been a problem that the attaching accuracy of the leading-end member to the rear-end member is poor.

In contrast, in Aspect 1, the axial center restrictor that restricts the position of the axial center of the leading-end member relative to the axial center of the rear-end member and the inclination restrictor that restricts the inclination of the leading-end member relative to the rear-end member are provided separately from the axial force generator. In this manner, by providing these restrictors separately from the axial force generator having a complicated shape such as a screw shape in which accuracy is difficult to obtain in order to generate the axial force, the axial center restrictor and the inclination restrictor can be formed into a shape such as a circular arc surface or a flat surface in which accuracy is easily obtained, and it is possible to attach with the position relative to the axial center of the rear-end member and the inclination of the leading-end member relative to the rear-end member accurately restricted. As a result, the leading-end member can be accurately attached to the rear-end member.

### Aspect 2

According to Aspect 2, in the liquid discharge head of Aspect 1, the inclination restrictor 183 includes a first seat surface 183a provided on the rear-end member 171 and perpendicular to an axial direction of the rear-end member 171, and a second seat surface 183b provided on the leading-end member 172 and perpendicular to an axial direction of the leading-end member 172, and the second seat surface 183b is brought into close contact with the first seat surface 183a by the axial force generated by the axial force generator such as the screw portion 180.

According to this, as described in the embodiment, the second seat surface 183b and the first seat surface 183a are flat surfaces, and the squareness relative to the axial direction such as the Z direction can be accurately obtained by cutting. Accordingly, by bringing the second seat surface 183b into close contact with the first seat surface 183a, the inclination of the leading-end member 172 relative to the rear-end member can be restricted with high accuracy. As a result, the leading-end member 172 can be attached to the rear-end member with satisfactorily suppressed inclination, and positional shift between the center of the needle valve leading-end member and the nozzle center can be suppressed. As a result, the discharge bending and sealing failure of the nozzle can be satisfactorily suppressed.

### Aspect 3

According to Aspect 3, in the liquid discharge head of Aspect 1 or 2, the axial center restrictor such as the inlay portion 182 includes a fitting hole 182a provided on the rear-end member 171 and a fitting portion 182b provided on the leading-end member 172 and fitted into the fitting hole 182a.

According to this, as described in the embodiment, the inner diameter dimension of the fitting hole 182a and the outer diameter dimension of the fitting portion can be easily and accurately formed by cutting. As a result, by fitting the fitting portion 182b into the fitting hole 182a, the axial center of the leading-end member can be accurately restricted relative to the axial center of the rear-end member.

### Aspect 4

According to Aspect 4, in the liquid discharge head of Aspect 3, the fitting portion 182b includes an introduction portion 182b1 having an outer diameter smaller than an inner diameter of the fitting hole 182a, and a final fitting portion 182b2 having an outer diameter larger than the inner diameter of the fitting hole 182a.

According to this, as described in Modification 1, since the introduction portion 182b1 having an outer diameter smaller than the inner diameter of the fitting hole 182a is included, the fitting portion 182b can be easily fitted into the fitting hole 182a, and the attaching workability of the leading-end member 172 to the rear-end member 171 can be improved.

By including the final fitting portion 182b2 having an outer diameter larger than the inner diameter of the fitting hole 182a, the final fitting portion 182b2 is press-fitted into the fitting hole 182a. As a result, the position of the axial center of the leading-end member can be accurately aligned with the position of the axial center of the rear-end member. Since the press-fitting is performed only at last, deterioration in attaching workability of the leading-end member 172 relative to the rear-end member 171 can be suppressed.

### Aspect 5

According to Aspect 5, in the liquid discharge head of Aspect 1, the rear-end member 171 and the leading-end member 172 include the first tapered surface portion 181a and the second tapered surface portion 181b serving as the axial center restrictor and the inclination restrictor that widen toward a nozzle side in a cross section parallel to an axial direction of the needle valve 17, and the tapered surface portion such as a second tapered surface portion 181b of the leading-end member 172 is brought into close contact with the tapered surface portion such as a first tapered surface portion 181a of the rear-end member 171 by the axial force generated by the axial force generator such as the screw portion 180.

According to this, as described in Modification 2, by bringing the tapered surface portion such as the second tapered surface portion 181b of the leading-end member 172 into close contact with the tapered surface portion such as the first tapered surface portion 181a of the rear-end member 171, it is possible to accurately restrict the inclination of the leading-end member and the axial center of the leading-end member.

### Aspect 6

According to Aspect 6, in the liquid discharge head of any one of Aspects 1 to 5, the leading-end member 172 holds a seal such as an O-ring 22 that seals between a liquid chamber 16 that stores liquid discharged from the nozzle 14, and a mover storage such as a storage 110 that stores the mover such as the moving mechanism 58.

According to this, as described in the embodiment, when the needle valve 17 is opened and closed, the seal such as the O-ring 22 that slides on the inner peripheral surface of the housing such as the housing to be worn can be replaced together with the leading-end member 172.

### Aspect 7

According to Aspect 7, in the liquid discharge head of Aspect 6, the seal such as the O-ring 22 is held on a leading-end member side of the needle valve 17 relative to the axial center restrictor such as the inlay portion 182 and the inclination restrictor 183.

According to this, it is possible to prevent the liquid in the liquid chamber from entering the axial center restrictor such as the inlay portion 182 and the inclination restrictor 183, and it is possible to prevent a decrease in accuracy due to dirt by the liquid. It is possible to prevent the occurrence of adherence due to liquid, and the leading-end member can be easily detached from the rear-end member.

### Aspect 8

According to Aspect 8, in the liquid discharge head of any one of Aspects 1 to 7, a seal that seals between a liquid chamber 16 that stores liquid to be discharged from the nozzle 14 and a mover storage such as a storage 110 that stores the mover such as the moving mechanism 58 is integrally molded with a main body of the leading-end member 172.

According to this, as described in Modification 3, the center of the main body of the leading-end member and the center of the seal portion can accurately conform to each other, and the abutting pressure of the seal portion with the housing can be made uniform. As a result, it is possible to suppress variations in sliding resistance of the seal portion with the housing and deformation of the seal.

### Aspect 9

According to Aspect 9, in the liquid discharge head of any one of Aspects 1 to 5, a diaphragm seal 122 including a through hole, with an end portion secured to a housing such as a housing 11, through which the needle valve 17 penetrates, with an edge portion of the through hole secured to the needle valve 17, the diaphragm seal 122 that seals between a liquid chamber 16 and a mover storage such as a storage 110 that stores the mover such as the moving mechanism 58 is included, in which the edge portion of the through hole of the diaphragm seal 122 is interposed to be secured between the leading-end member 172 and the rear-end member 171.

According to this, as described in Modification 4, when the leading-end member 172 is attached to the rear-end member 171, the edge of the hole through which the needle valve 17 penetrates of the diaphragm seal 122 can be secured to the needle valve 17, and the diaphragm seal 122 can be easily secured to the needle valve 17.

As illustrated in FIGS. 18(a) to 18(d), the edge portion of the through hole of the diaphragm seal 122 can be interposed and secured with a simple structure.

### Aspect 10

According to Aspect 10, in the liquid discharge head of any one of Aspects 1 to 5, a connection portion between the leading-end member 172 and the rear-end member 171 is located in a liquid chamber 16 that stores liquid to be discharged from the nozzle 14, and a seal such as a valve connection seal 189 that seals the connection portion is provided. The leading-end member 172 is referred to also as “the leading-end member”.

According to this, as described in Modification 5, the axial direction (Z direction) length of the needle valve of the leading-end member 172 can be shortened as compared with a case where the connection portion between the leading-end member 172 and the rear-end member 171 is located in the mover storage such as the storage 110 that stores the mover such as the moving mechanism 58. As a result, it is possible to suppress the shift between the axial center of the needle leading-end member and the center of the nozzle due to the inclination of the leading-end member relative to the rear-end member.

The seal such as the valve connection seal 189 can prevent the liquid from entering the attachment unit such as the screw portion 180, the axial center restrictor such as the inlay portion 182, and the inclination restrictor 183, and can prevent the decrease in accuracy due to dirt by the liquid. It is possible to prevent the occurrence of adherence due to liquid, and the leading-end member can be easily detached from the rear-end member.

### Aspect 11

According to Aspect 11, in the liquid discharge head of any one of Aspects 1 to 10, a member provided with the nozzle 14 (formed of a nozzle plate 15 and a nozzle housing 11b in the present embodiment) is configured to be attachable to and detachable from a main body housing such as a main body housing 11a.

According to this, as described in the embodiment, by removing the member provided with the nozzle 14 (in the present embodiment, formed of the nozzle plate 15 and the nozzle housing 11b) from the main body housing 11a, the leading-end member is exposed and the leading-end member can be easily replaced.

A combination of the leading-end member 172 that can satisfactorily seal and the member provided with the nozzle (nozzle) can be obtained according to the liquid to be discharged. This makes it possible to cope with various liquids.

### Aspect 12

According to Aspect 12, in the liquid discharge head of any one of Aspects 1 to 11, the axial force generator has a screw structure, a magnet, a shrinking tube, or a bayonet structure.

According to this, as described in the embodiment, the axial force can be generated.

### Aspect 13

According to Aspect 13, in a liquid discharge apparatus including a liquid discharge head 10, the liquid discharge head of any one of Aspects 1 to 13 is used as the liquid discharge head 10.

According to this, it is possible to satisfactorily seal the nozzle over time, and cope with various liquids.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a needle valve to open and close a nozzle, the needle valve including:
a rear-end member; and
a leading-end member detachably attached to the rear-end member; and
a mover coupled to the rear-end member of the needle valve, the mover to move the needle valve, in an axial direction, between:
a closed position at which the needle valve contacts the nozzle to close the nozzle; and
an open position at which the needle valve is separated from the nozzle to open the nozzle,
wherein the needle valve further includes:
an axial force generator to generate an axial force to abut the leading-end member against the rear-end member;
an axial center restrictor to restrict a position of an axial center of the leading-end member relative to an axial center of the rear-end member; and
an inclination restrictor to restrict an inclination of the leading-end member relative to the rear-end member.

2. The liquid discharge head according to claim 1,
wherein the inclination restrictor includes:
a first seat surface on the rear-end member and perpendicular to the axial direction; and
a second seat surface on the leading-end member and perpendicular to the axial direction, and
the axial force generator generates the axial force to cause the second seat surface to contact with the first seat surface.

3. The liquid discharge head according to claim 1,
wherein the axial center restrictor includes:
a fitting hole in the rear-end member; and
a fitting portion in the leading-end member, and
the fitting portion is fitted into the fitting hole.

4. The liquid discharge head according to claim 3,
wherein the fitting portion includes:
an introduction portion having an outer diameter smaller than an inner diameter of the fitting hole; and
a final fitting portion having an outer diameter larger than the inner diameter of the fitting hole.

5. The liquid discharge head according to claim 1,
wherein each of the axial center restrictor and the inclination restrictor includes a tapered surface portion on each of the rear-end member and the leading-end member,
the tapered surface portion widens toward the nozzle in a cross-section parallel to the axial direction, and
the axial force generator generates the axial force to cause the tapered surface portion on the leading-end member to contact with the tapered surface portion on the rear-end member.

6. The liquid discharge head according to claim 1, further comprising:
a liquid chamber to store a liquid discharged from the nozzle;
a mover storage to store the mover; and
a seal to seal a portion between the liquid chamber and the mover storage,
wherein the leading-end member holds the seal.

7. The liquid discharge head according to claim 6,
wherein the leading-end member holds the seal at a position closer to a leading-end side than the axial center restrictor and the inclination restrictor in the axial direction.

8. The liquid discharge head according to claim 1, further comprising:
a liquid chamber to store a liquid discharged from the nozzle;
a mover storage to store the mover;
a first seal to seal a portion between the liquid chamber and the mover storage; and
a second seal at a leading end of the leading-end member to seal the nozzle,
wherein the first seal and the second seal are formed as a single member.

9. The liquid discharge head according to claim 1, further comprising:
a housing to house the needle valve;
a mover storage to store the mover;
a liquid chamber to store a liquid discharged from the nozzle;
a diaphragm seal having a through hole through which the needle valve is penetrable,
wherein the diaphragm seal has:
a peripheral portion secured to the housing; and
an inner edge portion of the through hole secured between the leading-end member and the rear-end member of the needle valve, and
the diaphragm seal seals a portion between the liquid chamber and the mover storage.

10. The liquid discharge head according to claim 1, further comprising:
a liquid chamber to store a liquid discharged from the nozzle;
a connection portion between the leading-end member and the rear-end member of the needle valve in the liquid chamber; and
a seal sealing the connection portion.

11. The liquid discharge head according to claim 1, further comprising:
a housing to house the needle valve and the mover; and
a nozzle plate detachably attachable to the housing.

12. The liquid discharge head according to claim 1,
wherein the axial force generator has one of:
a screw structure;
a magnet;
a shrinking tube; or
a bayonet structure.

13. A liquid discharge apparatus comprising:
the liquid discharge head according to claim 1; and
a scanner to move the liquid discharge head.
